(19) United States
(12) Patent Application Publication
(10) Pub. No.: US 2026/0303185 A1
(43) Pub. Date: Oct. 1, 2026

(54) METHOD AND DEVICE FOR MEASURING AND REPORTING CSI FOR BEAM OPERATION IN WIRELESS COMMUNICATION SYSTEM

(71) Applicant: Samsung Electronics Co., Ltd., Suwon-si, Gyeonggi-do (KR)

(72) Inventors: Youngrok JANG, Suwon-si (KR); Yeongeun LIM, Suwon-si (KR); Ameha Tsegaye ABEBE, Suwon-si (KR); Hyoungju JI, Suwon-si (KR); Taehan BAE, Suwon-si (KR)

(21) Appl. No.: 19/157,160

(22) PCT Filed: Feb. 16, 2024
(86) PCT No.: PCT/KR2024/095268

§ 371 Date: Aug. 15, 2025

(30) Foreign Application Priority Data
Feb. 16, 2023 (KR) 10-2023-0021023
Apr. 6, 2023 (KR) 10-2023-0045309

(51) Int. Cl. H04B 7/06; H04W 24/10; H04W 72/12; H04W 72/232

(52) U.S. Cl. CPC H04B 7/06952; H04W 24/10; H04W 72/12; H04W 72/232

(57) ABSTRACT

The present disclosure relates to a 5G or 6G communication system for supporting higher data transmission rates. The present disclosure may be applied to intelligent services (for example, smart homes, smart buildings, smart cities, smart cars or connected cars, healthcare, digital education, retail business, security and safety-related services, etc.) based on 5G communication technology and IoT-related technology. According to the present disclosure, a method performed by a user equipment (UE) in a wireless communication system comprises the steps of: receiving, from a base station, first configuration information related to measurement for beam management and second configuration information associated with the first configuration information and including information about one or more downlink reference signal resources respectively related to different beams for performing the measurement, wherein the first configuration information includes information for setting the number of second measurement results used for reporting measurement results among first measurement results for the one or more downlink reference signal resources; receiving a downlink reference signal on the one or more downlink reference signal resources from the base station on the basis of information about the one or more downlink reference signal resources; acquiring the first measurement results on the basis of the received downlink reference signal; and transmitting, to be base station, the measurement result report based on the set number of the second measurement results and including a reference measurement result based on the first measurement results, wherein the measurement result report includes information about the reference measurement result and information about the differential between the reference measurement result and each of one or more measurement results other than the reference measurement result, and the range of values represented by the information about the differential may be determined on the basis of a value indicated by information for setting the number.

### TECHNICAL FIELD

The disclosure relates to a wireless communication system (or mobile communication system). Specifically, the disclosure relates to a device and a method for channel state information (CSI) measurement and reporting for beam operation in a wireless communication system (or mobile communication system).

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHZ”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, with the advancement of communication systems, there is an increasing need to efficiently provide CSI measurement and reporting procedures, and in particular, the demand for improving the CSI measurement and reporting process for beam operation is growing day by day.

### DISCLOSURE OF INVENTION

### Technical Problem

The disclosure is to provide a device and a method for CSI measurement and reporting for beam operation in a wireless communication system.

The disclosure is to provide a method of receiving a CSI reference signal (CSI-RS) by a terminal in a wireless communication system, and a method of reporting CSI measured by a terminal.

According to the disclosure, a method for enabling beam operation comparable to that of the existing system in which the amount of CSI reporting is not reduced even if the amount of CSI reporting for beam operation is reduced in a wireless communication system is to be provided.

According to the disclosure, a method for enabling beam operation comparable to that of the existing system in which CSI-RSs are not reduced even if the amount of CSI-RSs for beam operation is reduced in a wireless communication system is to be provided.

### Solution to Problem

According to an embodiment of the disclosure, a method performed by a user equipment (UE) in a wireless communication system may include receiving, from a base station, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources, receiving, from the base station, a downlink reference signal on the one or more downlink reference signal resources, based on the information on the one or more downlink reference signal resources, obtaining the first measurement results, based on the received downlink reference signal, and transmitting, to the base station, the measurement result report that is based on the configured number of the second measurement results including a reference measurement result based on the first measurement results, wherein the measurement result report includes information on the reference measurement result and information on a differential of, from the reference measurement result, each of one or more measurement results other than the reference measurement result, and wherein a range of a value indicated by the information on the differential is determined based on a value indicated by the information for configuring the number.

According to an embodiment of the disclosure, a method performed by a base station in a wireless communication system may include transmitting, to a UE, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources, transmitting, to the UE, a downlink reference signal on the one or more downlink reference signal resources, based on the information on the one or more downlink reference signal resources, and receiving, from the UE, the measurement result report that is based on the configured number of the second measurement results including a reference measurement result based on the first measurement results based on the transmitted downlink reference signal, wherein the measurement result report includes information on the reference measurement result and information on a differential of, from the reference measurement result, each of one or more measurement results other than the reference measurement result, and wherein a range of a value indicated by the information on the differential is determined based on a value indicated by the information for configuring the number.

According to an embodiment of the disclosure, a user equipment (UE) in a wireless communication system may include a transceiver and a controller connected to the transceiver, wherein the controller is configured to receive, from a base station, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources, receive, from the base station, a downlink reference signal on the one or more downlink reference signal resources, based on the information on the one or more downlink reference signal resources, obtain the first measurement results, based on the received downlink reference signal, and transmit, to the base station, the measurement result report that is based on the configured number of the second measurement results including a reference measurement result based on the first measurement results, wherein the measurement result report includes information on the reference measurement result and information on a differential of, from the reference measurement result, each of one or more measurement results other than the reference measurement result, and wherein a range of a value indicated by the information on the differential is determined based on a value indicated by the information for configuring the number.

According to an embodiment of the disclosure, a base station in a wireless communication system may be configured to transmit, to a UE, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources, transmit, to the UE, a downlink reference signal on the one or more downlink reference signal resources, based on the information on the one or more downlink reference signal resources, and receive, from the UE, the measurement result report that is based on the configured number of the second measurement results including a reference measurement result based on the first measurement results based on the transmitted downlink reference signal, wherein the measurement result report includes information on the reference measurement result and information on a differential of, from the reference measurement result, each of one or more measurement results other than the reference measurement result, and wherein a range of a value indicated by the information on the differential is determined based on a value indicated by the information for configuring the number.

### Advantageous Effects of Invention

According to the embodiments proposed in the disclosure, the amount of CSI-RSs and CSI reporting required for a beam operation scheme providing high beamforming gain in a wireless communication system may be reduced. In addition, even if the amount of CSI-RSs and CSI reporting required for a beam operation scheme is reduced, it is possible to maintain high quality of beam reception sensitivity, thereby not only increasing a data transmission rate but also providing highly reliable service.

### BRIEF DESCRIPTION OF DRAWINGS

FIG. 1 illustrates a basic structure of a time-frequency domain, which is a radio resource domain used to transmit data or control channels, in a 5G wireless communication system.

FIG. 2 illustrates an example of a slot structure used in a 5G wireless communication system.

FIG. 3 illustrates an example of a bandwidth part (BWP) configuration in a 5G wireless communication system.

FIG. 4 illustrates an example of a control resource set (CORESET) used to transmit a downlink control channel in a 5G wireless communication system.

FIG. 5 illustrates a structure of a downlink control channel in a 5G wireless communication system.

FIG. 6 illustrates an example of an uplink and downlink resource configuration method in a wireless communication system.

FIG. 7 illustrates an example of base station beam allocation according to transmission configuration indicator (TCI) state configurations in a wireless communication system according to an embodiment of the disclosure.

FIG. 8 illustrates an example of a method for allocating a TCI state to a physical downlink control channel (PDCCH) in a wireless communication system according to an embodiment of the disclosure

FIG. 9 illustrates a TCI indication medium access control (MAC) control element (CE) signaling structure for a PDCCH demodulation reference signal (DMRS).

FIG. 10 illustrates an example of a beam configuration with regard to a control resource set (CORESET) and a search space according to the above description.

FIG. 11 illustrates a method in which, upon receiving a downlink control channel, a UE selects a receivable control resource set in consideration of priority in a wireless communication system according to an embodiment of the disclosure.

FIG. 12 illustrates an example of frequency domain resource allocation with regard to a physical downlink shared channel (PDSCH) in a wireless communication system according to an embodiment of the disclosure.

FIG. 13 illustrates an example of a process for a beam configuration and activation with regard to a PDSCH.

FIG. 14 illustrates an example of physical uplink shared channel (PDSCH) repetition type B according to an embodiment of the disclosure.

FIG. 15 illustrates an example of aperiodic CSI reporting according to an embodiment of the disclosure.

FIG. 16 illustrates another example of aperiodic CSI reporting according to an embodiment of the disclosure.

FIG. 17 illustrates an example of beam measurement and reporting for beam estimation according to an embodiment of the disclosure.

FIG. 18 illustrates an example of a method of performing CSI measurement and reporting for beam operation by a terminal when multiple CSI-SSB-ResourceSets or non-zero power (NZP)-CSI-RS-ResourceSets are configured, according to an embodiment of the disclosure.

FIG. 19 illustrates an example of a method of measuring CSI for beam operation and reporting single part CSI by a terminal when a single CSI-SSB-ResourceSet or NZP-CSI-RS-ResourceSet is configured, according to an embodiment of the disclosure.

FIG. 20 illustrates an example of a method of measuring CSI for beam operation and reporting two part CSI by a terminal when a single of CSI-SSB-ResourceSet or NZP-CSI-RS-ResourceSet is configured, according to an embodiment of the disclosure.

FIG. 21 is a block diagram illustrating a structure of a UE according to an embodiment of the disclosure.

FIG. 22 is a block diagram illustrating a structure of a base station according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. Also, the terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) (or eNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

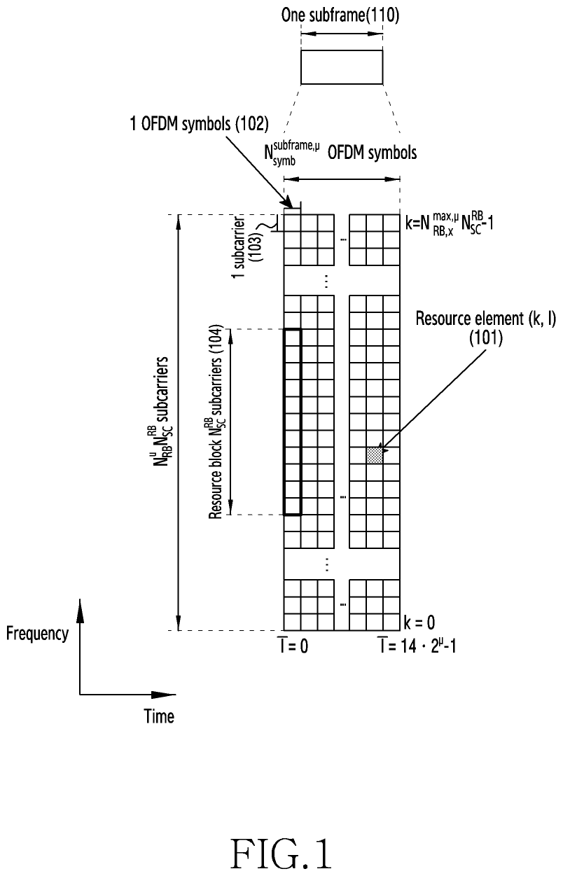

FIG. 1 illustrates a basic structure of a time-frequency domain, which is a radio resource domain used to transmit data or control channels, in a 5G wireless communication system.

Referring to FIG. 1, the horizontal axis represents a time domain, and the vertical axis represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain,

$${N}_{sc}^{RB}$$

(for example, 12) consecutive REs may constitute one resource block (RB) 104.

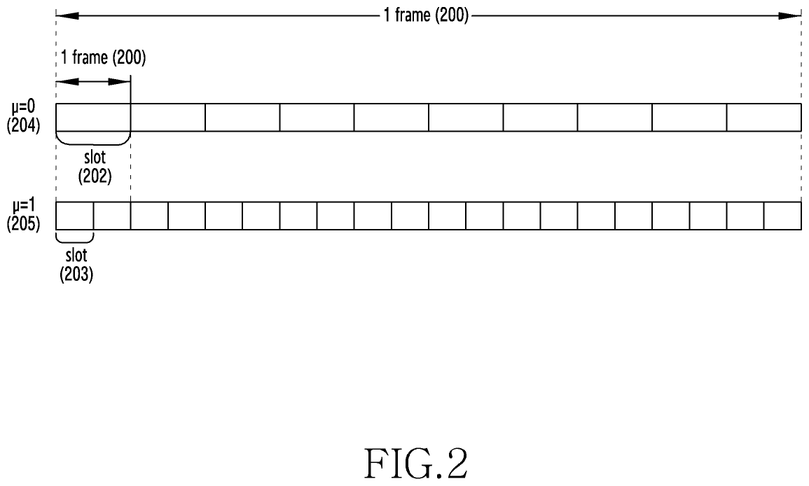

FIG. 2 illustrates an example of a slot structure used in a 5G wireless communication system.

Referring to FIG. 2, an example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbls per one slot

$${N}_{symb}^{slot} = 14 ) .$$

One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

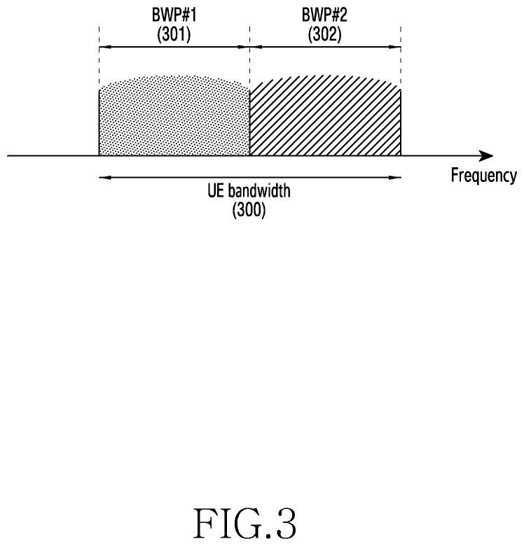

FIG. 3 illustrates an example of a bandwidth part (BWP) configuration in a 5G wireless communication system.

Referring to FIG. 3, FIG. 3 illustrates an example in which a UE bandwidth 300 is configured to include two bandwidth parts, that is, bandwidth part #1 (BWP#1) 301 and bandwidth part #2 (BWP #2) 302. A base station may configure one or multiple bandwidth parts for a UE, and may configure the following pieces of information with regard to each bandwidth part as given below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

```
      n5},
    (subcarrier spacing)
```

| | |
|---|---|
| cyclicPrefix | ENUMERATED { extended } |

(cyclic prefix)
}

Of course, the bandwidth part configuration is not limited to the above example in Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered to have identity (ID) 0. The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. In this case, the identity (ID) of the initial bandwidth part may be considered 0.

The bandwidth part-related configuration supported by the 5G wireless communication system may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part (initial BWP) through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured through the MIB may be regarded as an initial bandwidth part, and the UE may receive, through the configured initial bandwidth part, a PDSCH through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | [1] | [3] |
| 1 | 0.5 | [2] | [5] |
| 2 | 0.25 | [3] | [9] |
| 3 | 0.125 | [6] | [17] |

^{Note 1}:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0 1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in a 5G wireless communication system will be described.

An SS/PBCH block may refer to a physical layer channel block including a primary synchronization signal (PSS), a secondary synchronization signal (SSS), and a PBCH. Details thereof may be as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and from this, control resource set (CORESET) #0 (which may correspond to a control resource set having a control resource set index of 0) may be configured for the UE. The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G wireless communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI), modulation coding scheme C-RNTI (MCS-C-RNTI), or configured scheduling RNTI (CS-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

```
TABLE 4
  - Identifier for DCI formats - 1 bit
    - The value of this bit field is always set to 0, indicating, an UL DCI format
  $‐ Frequency domain resource assignment - ⌈ {log}_{2} ( {N}_{RB}^{UL , BWP} ( {N}_{RB}^{UL , BWP} + 1 ) / 2 ) ⌉$
    $bits where {N}_{RB}^{UL , BWP} is defined in subclause 7.3 \text{.1} \text{.0}$
    - For PUSCH hopping with resource allocation type 1:
        - N_{UL}_hop MSB bits are used to indicate the frequency offset according to Subclause 6.3 of [6, TS
          38.214], where N_{UL}_hop = 1 if the higher layer parameter frequencyHoppingOffsetLists contains two
          offset values and N_{UL}_hop = 2 if the higher layer parameter frequencyHoppingOffsetLists contains
          four offset values
        $‐ ⌈ {log}_{2} ( {N}_{RB}^{UL , BWP} ( {N}_{RB}^{UL , BWP} + 1 ) / 2 ) ⌉ - {N}_{UL , hop} bits provides the frequency domain resource allocation$
          according to Subclause 6.1.2.2.2 of [6, TS 38.214]
    - For non-PUSCH hopping with resource allocation type 1:
        $‐ ⌈ {log}_{2} ( {N}_{RB}^{UL , BWP} ( {N}_{RB}^{UL , BWP} + 1 ) / 2 ) ⌉ bits provides the frequency domain resource allocation according$
          to Subclause 6.1.2.2.2 of [6, TS 38.214]
  - Time domain resource assignment - 4 bits as defined in Subclause 6.1.2.1 of [6,
      TS 38.214]
  - Frequency hopping flag - 1 bit according to Table 7.3.1.1.1-3, as defined in
      Subclause 6.3 of [6, TS 38.214]
  - Modulation and coding scheme - 5 bits as defined in Subcaluse 6.1.4.1 of [6, TS
      38.214]
  - New data indicator - 1 bit
  - Redundancy version - 2 bits as defined in Table 7.3.1.1.1-2
  - HARQ process number - 4 bits
  - TPC command for scheduled PUSCH (transmit power control command for scheduled PUSCH) - 2 bits as
      defined in Subclause 7.1.1 of [5, TS 38.213]
  - Padding bits, if required.
  - UL/SUL indicator (uplink/supplementary uplink (supplementary UL) indiator) - 1 bit for UEs
      configured with supplementaryUplink in ServingCellConfig in the cell as defined in TABLE 7.3.1.1.1-1 and
      the number of bits for DCI format 1_0 before padding in larger than the number of bits for DCI format 0_0
      before padding, 0 bit othewise. The UL/SUL indicator, if present, locates in the last bit position of DCI
      format 0_0 after the padding bit(s).
      - If the UL/SUL indicator is present in DCI format 0_0 and the higher layer parameter pusch-Config is not
        configured on both UL and SUL the UE ignores the UL/SUL indicator field in DCI format 0_0 and the
        corresponding PUSCH scheduled by the DCI format 0_0 is for the UL or SUL for which high layer
        parameter pucch-Config is configured;
      - If the UL/SUL indicator is not present in DCI format 0_0 and pucch-Config is configured, the
        corresponding PUSCH scheduled by the DCI format 0_0 is for the UL or SUL for which high layer
        parameter pucch-Config is configured.
      - If the UL/SUL indicator is not present in DCI format 0_0 and pucch-Config is not configured, the
        corresponding PUSCH scheduled by the DCI format 0_0 is for the uplink on which the latest PRACH is
        transmitted.
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
      - Identifier for DCI for - 1 bit
        - The value of this bit field is always set to 0, indicating, an UL DCI format
      - Carrier indicator - 0 or 3 bits, as defined in Subclause 10.1 of [5, TS 38.213].
      - UL/SUL indicator (uplink/supplementary uplink (supplementary UL) indicator) - 0 bit for UEs not
        configured with supplementaryUplink in ServingCellConfig in the cell or UEs configured with
        supplementaryUplink in ServingCellConfig in the cell but only PUCCH carrier in the cell is configured for
        PUSCH transmission; otherwise, 1 bit as defined in Table 7.3.1.1.1-1.
      - Bandwidth part indicator - 0, 1 or 2 bits as determined by the number of UL BWPs
        n_{BWP,RRC} configured by higher layers, excluding the initial UL bandwidth part. The bitwidth for this field is
        determined as ┌log₂(n_{BWP})┐ bits, where
        - n_{BWP} = n_{BWP,RRC} +1 if n_{BWP,RRC} ≤ 3, in which case the bandwidth part indicator is equivalent to the
          ascending order of the higher layer parameter BWP-Id;
        - otherwise n_{BWP} = n_{BWP,RRC}, in which case the bandwidth part indicator is defined in Table 7.3.1.1.2-1;
        If a UE does not support active BWP change via DCI, the UE ignores this bit field.
      - Frequency domain resource assignment - number of bits dermined by the
        $following where {N}_{RB}^{UL , BWP} is the size of the active UL bandwidth part :$
        - N_{RBG} bits if only resource allocation type 0 is configured, where N_{RBG} is defined in Subcaluse
          6.1.2.2.1 of [6, TS 38.214],
        $‐ ⌈ {log}_{2} ( {N}_{RB}^{UL , BWP} ( {N}_{RB}^{UL , BWP} + 1 ) / 2 ) ⌉ bits if only resource allocation type 1 is configured , or$
          $max ( ⌈ {log}_{2} ( {N}_{RB}^{UL , BWP} ( {N}_{RB}^{UL , BWP} + 1 ) / 2 ) ⌉ , {N}_{RBG} ) + 1 bits if both resource allocation type 0 and 1 are$
          configured
        - If both resource allocation type 0 and 1 are configured, the MSB bit is used to indicate resource
          allocation type 0 or resource allocation type 1, where the bit value of 0 indicates resource allocation type
      0 and the bit value of 1 indicates resource allocation type 1.
  - For resource allocation type 0, the N_{RBG} LSBs provide the resource allocation as defined in Subclause
      6.1.2.2.1 of [6, TS 38.214].
  $‐ For resource allocation type 1 , the ⌈ {log}_{2} ( {N}_{RB}^{UL , BWP} ( {N}_{RB}^{UL , BWP} + 1 ) / 2 ) ⌉ LSBs provide the resource$
      allocation as follows:
      - For PUSCH hopping with resource allocation type 1:
        - N_{UL}_hop MSB bits are used to indicate the frequency offset according to Subclause 6.3 of [6, TS
            38.214], where N_{UL}_hop = 1 if the higher layer parameter frequencyHoppingOffsetLists contains
            two offset values and N_{UL}_hop = 2 if the higher layer parameter frequencyHoppingOffsetLists
            contains four offset values
        $‐ ⌈ {log}_{2} ( {N}_{RB}^{UL , BWP} ( {N}_{RB}^{UL , BWP} + 1 ) / 2 ) ⌉ - {N}_{UL , hop} bits provides the frequency domain resource$
            allocation according to Subclause 6.1.2.2.2 of [6, TS 38.214]
      - For non-PUSCH hopping with resource allocation type 1:
        $‐ ⌈ {log}_{2} ( {N}_{RB}^{UL , BWP} ( {N}_{RB}^{UL , BWP} + 1 ) / 2 ) ⌉ bits provides the frequency domain resource allocation$
            according to Subclause 6.1.2.2.2 of [6, TS 38.214]
      If “Bandwidth part indicator” field indicates a bandwidth part other than the active bandwidth part and if
      both resource allocation type 0 and 1 are configured for the indicated bandwidth part, the UE assumes
      resource allocation type 0 for the indicated bandwidth part if the bitwidth of the “Frequency domain
      resource assignment” field of the active bandwidth part is smaller than the bitwidth of the “Frequency
      domain resource assignment” field of the indicated bandwidth part.
  - Time domain resource assignment - 0, 1, 2, 3, or 4 bits as defined in Subclause
      6.1.2.1 of [6, TS 38.214]. The bitwidth for this field is determined as ┌log₂(I)┐ bits, where I is the number
      of entries in the higher layer parameter pusch-TimeDomainAllocationList if the higher layer parameter is
      configured; otherwise I is the number of entries in the default table.
  - Frequency hopping flag - 0 or 1 bit:
      - 0 bit if only resource allocation type 0 is configured or if the higher layer parameter frequencyHopping is
        not configured;
      - 1 bit according to Table 7.3.1.1.1-3 otherwise, only applicable to resource allocation type 1, as defined in
        Subclause 6.3 of [6, TS 38.214].
  - Modulation and coding scheme - 5 bits as defined in Subclause 6.1.4.1 of [6, TS
      38.214]
  - New data indicator - 1 bit
  - Redundancy version - 2 bits as defined in Table 7.3.1.1.1-2
  - HARQ process number - 4 bits
  - 1^{st} downlink assignment index - 1 or 2 bits:
      - 1 bit for semi-static HARQ-ACK codebook:
      - 2 bits for dynamic HARQ-ACK codebook.
  - 2^{nd} downlink assignment index - 0 or 2 bits:
      - 2 bits for dynamic HARQ-ACK codebook with two HARQ-ACK sub-codebooks;
      - 0 bit otherwise.
  - TPC command for scheduled PUSCH (transmit power control command for scheduled PUSCH) - 2 bits as
      defined in Subclause 7.1.1 of [5, TS 38.213]
  - SRS resource indicator (sounding reference signal (SRS) resource indicator)
      $⌈ {log}_{2} ( {\sum }_{k = 1}^{min [ {L}_{ma x} {N}_{SRS} ]} ( \begin{matrix}{N}_{SRS} \\ k\end{matrix} ) ) ⌉ or ⌈ {log}_{2} ( {N}_{SRS} ) ⌉ bits , where {N}_{SRS} is the number of configured SRS$
      resources in the SRS resource set associated with the higher layer parameter usage of value ‘codeBook’ or
      ‘nonCodeBook’,
      $‐ ⌈ {log}_{2} ( {\sum }_{k = 1}^{min [ {L}_{ma x} {N}_{SRS} ]} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer$
        parameter txConfig = nonCodebook, where N_{SRS} is the number of configured SRS resources in the
        SRS resource set associated with the higher layer parameter usage of value ‘nonCodeBook’ and
        - if UE supports operation with maxMIMO-Layers and the higher layer parameter maxMIMO-Layers
          of PUSCH-ServingCellConfig of the serving cell is configured. Lₘₐₓ is given by that parameter
        - otherwise, Lₘₐₓ is given by the maximum number of layers for PUSCH supported by the UE for the
          serving cell for non-codebook based operation.
      - ┌log₂(N_{SRS})┐ bits according to Tables 7.3.1.1.2-32 if the higher layer parameter txConfig = codebook,
        where N_{SRS} is the number of configured SRS resources in the SRS resource set associated with the
        higher layer parameter usage of value ‘codeBook’.
  - Precoding information and number of layers - number of bits
      determined by the following:
      - 0 bits if the higher layer parameter txConfig - nonCodeBook;
      - 0 bits for 1 antenna port and if the higher layer parameter txConfig = codebook;
      - 4.5, or 6 bits according to Table 7.3.1.1.2-2 for 4 antenna ports, if txConfig = codebook, and according
        to whether transform precoder is enabled or disabled, and the values of higher layer parameters
        maxRank, and codebookSubset;
      - 2, 4, or 5 bits according to Table 7.3.1.1.2-3 for 4 antenna ports, if txConfig = cookbook, and according
        to whether transform precoder is enabled or disabled, and the values of higher layer parameters
        maxRank, and codebookSubset;
      - 2 or 4 bits according to Table 7.3.1.1.2-4 for 2 antenna ports, if txConfig = cookbook, and according to
        whether transform precoder is enabled or disabled, and the values of higher layer parameters maxRank
        and codebookSubset;
      - 1 or 3 bits according to Table 7.3.1.1.2-5 for 2 antenna ports, if txConfig = cookbook, and according to
        whether transform precoder is enabled or disabled, and the values of higher layer parameters maxRank
        and codebookSubset;
  - Antenna ports - number of bits determined by the following
      - 2 bits as defined by Tables 7.3.1.1.2-6, if transform precoder is enabled, dmrs-Type = 1, and
        maxLength = 1;
      - 4 bits as defined by Tables 7.3.1.1.2-7, if transform precoder is enabled, dmrs-Type = 1, and
        maxLength = 2;
      - 3 bits as defined by Tables 7.3.1.1.2-8/9/10/11, if transform precoder is disabled, dmrs-Type = 1, and
        maxLength = 1, and the value of rank is determined according to the SRS resource indicator field if the
        higher layer parameter txConfig = nonCodebook and according to the Precoding information and number
        of layers field if the higher layer parameter txConfig = codebook;
      - 4 bits as defined by Tables 7.3.1.1.2-12/13/14/15, if transform precoder is disabled, dmrs-Type = 1, and
        maxLength = 2, and the value of rank is determined according to the SRS resource indicator field if the
        higher layer parameter txConfig = nonCodebook and according to the Precoding information and number
        of layers field if the higher layer parameter txConfig = codebook;
      - 4 bits as defined by Tables 7.3.1.1.2-16/17/18/19, if transform precoder is disabled, dmrs-Type = 2, and
        maxLength = 1, and the value of rank is determined according to the SRS resource indicator field if the
        higher layer parameter txConfig = nonCodebook and according to the Precoding information and number
        of layers field if the higher layer parameter txConfig = codebook;
      - 5 bits as defined by Tables 7.3.1.1.2-20/21/22/23, if transform precoder is disabled, dmrs-Type = 2, and
        maxLength = 2, and the value of rank is determined according to the SRS resource indicator field if the
        higher layer parameter txConfig = nonCodebook and according to the Precoding information and number
        of layers field if the higher layer parameter txConfig = codebook;
      where the number of CDM groups without data of values 1, 2, and 3 in Tables 7.3.1.1.2-6 to 7.3.1.1.2-23
      refers to CDM groups {0}, {0, 1}, and {0, 1, 2} respectively.
      If a UE is configured with both dmrs-UplinkForPUSCH-MappingTypeA and dmrs-UplinkForPUSCH-
      MappingTypeB, the bitwidth of the field equals max {x_{A}, x_{B}}, where x_{A} is the “Antenna ports” bitwidth
      derived according to dmrs-UplinkForPUSCH-MappingTypeA and x_{B} is the “Antenna ports” bitwidth
      derived according to dmrs-UplinkForPUSCH-MappingTypeB. A number of |x_{A} − x_{B}| zeros are padded in
      the MSB of this field, if the mapping type of the PUSCH corresponds to the smaller value of x_{A} and x_{B}.
  - SRS request (SRS [symbol] ) - 2 bits as defined by Table 7.3.1.1.2-24 for UEs not configured with
      supplementaryUplink in ServingCellConfig in the cell; 3 bits for UEs configured with supplemenatryUplink
      in ServingCellConfig in the celll where the cell where the first bit is the non-SUL/SUL indicator as defined in Table
      7.3.1.1.1-1 and the second and third bits are defined by Table 7.3.1.1.2-24. This bit field may also indicate
      the associated CSI-RS according to Subclause 6.1.1.2 of [6, TS 38.214].
  - CSI request ( [symbol]  (Channel State Information: CSI) [symbol] ) - 0, 1, 2, 3, 4, 5, or 6 bits
      determined by higher layer parameter reportTriggerSize.
  - CBG transmission information (CBGTI) (code block group (CBG) transmission information) - 0 bit
      if higher layer parameter codeBlockGroupTransmission for PDSCH is not configured, otherwise, 2, 4, 6, or
      8 bits determined by higher layer parameter maxCodeBlockGroupsPerTransmportBlock for PUSCH.
  - PTRS-DMRS association (phase tracking reference signal (PTRS) - demodulation reference
      signal (DMRS) association) - number of bits determined as follows
      - 0 bits if PTRS-UplinkConfig is not configured and transform precoder is disabled, or if transform
        precoder is enabled, of if maxRank = 1;
      - 2 bits otherwise, where Table 7.3.1.1.2-25 and 7.3.1.1.2-26 are used to indicate the association between
        PTRS port(s) and DMRS port(s) for transmission of one PT-RS port and two PT-RS ports respectively,
        and the DMRS ports are indicated by the Antenna ports field.
      If “Bandwidth part indicator” field indicates a bandwidth part other than the active bandwidth part and the
      “PTRS-DMRS association” field is present for the indicated bandwidth part but not present for the active
      bandwidth part, the UE assumes the “PTRS-DMRS association” field is not preesent for the indicated
      bandwidth part.
  - offset_offset indicator - 0 if the higher layer parameter betaOffsets = semiStatic;
      otherwise 2 bits as defined by Table 9.3-3 in [5, TS 38.233],
  - DMRS sequence initialization - 0 bit if transform precoder is enabled;
      1 bit if transform precoder is disabled.
  - UL-SCH indicator (uplink-shared channel (UL-SCH) indicator) - 1 bit. A value of “1” indicates UL-SCH
      shall be transmitted on the PUSCH and a value of “0” indicates UL-SCH shall not be transmited on the
      PUSCH. Except for DCI format 0_1 with CRC scrambled by SP-CSI-RNTI, a UE is not expected to receive
      a DCI format 0_1 with UL-SCH indistor of “0” and CSI request of all zero(s).
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
  - Identifier for DCI formats - 1 bit
    - The value of this bit field is always set to 1, indicating, an DL DCI format
  $‐ Frequency domain resource assignment - ⌈ {log}_{2} ( {N}_{RB}^{UL , BWP} ( {N}_{RB}^{UL , BWP} + 1 ) / 2 ) ⌉$
    $bits where {N}_{RB}^{UL , BWP} is defined in subclause 7.3 \text{.1} \text{.0}$
  If the CRC of the DCI formal 1_0 is scrambled by C-RNTI and the “Frequency domain resource assignment”
  field are of all ones, the DCI format 1_0 is for random access procedure initiated by a PDCCH order, with all
  remaining fields set as follows:
  - Random Access Preamble index - 6 bits according to ra-PreambleIndex
    in Subclause 5.1.2 of [8, TS 38.321]
  - UL/SUL indicator (uplinl/supplementary uplink (supplementary UL) indicator) - 1 bit. If the value of
    the “Random Access Preamble index” is not all zeros and if the UE is configured with supplementaryUplink
    in ServingCellConfig in the cell, this field indicates which UL carrier in the cell to transmit the PRACH
    according to Table 7.3.1.1.1-1; otherwise, this field is reserved
  - SS/PBCH index (synchronization signal (SS)/physical broadcast channel (PBCH)
    index) - 6 bits. If the value of the “Random Access Preamble index” is not all zeros, this
    field indicates the SS/PBCH that shall be used to determine the RACH occasion for the PRACH
    transmission; otherwise, this field is reserved.
  - PRACH Mask index (physical random access channel (PRACH) mask
    index) - 4 bits. If the value of the “Random Access Preamble index” is not all zeros, the field indicates the
    RACH occasion associated with the SS/PBCH indicated by “SS/PBCH index” for the PRACH transmission,
    according to Subclause 5.1.1 of [8, TS 38.321]; otherwise, this field is reserved
  - Reserved bits - 10 bits
    Otherwise, all remaining fields are set as follows:
  - Time domain resource assignment - 4 bits as defined in Subclause 5.1.2.1 of [6,
    TS, 38.214]
  - VRB-to-PRB mapping (virtual resource block (VRB)-to-physical resource block (PRB)
    mapping) - 1 bit according to Table 7.3.1.2.2-5
  - Modulation and coding scheme - 5 bits as defined in Subclause 5.1.3 of [6, TS 38.214]
  - New data indicator - 1 bit
  - Redundancy version - 2 bits as defined in Table 7.3.1.1.1-2
  - HARQ process number - 4 bits
  - Downlink assignment index - 2 bits as defined in Subclause 9.1.3 of [5, TS
    38.213], as counter DAI
  - TPC command for scheduled PUCCH (transmit power control command for scheduled PUSCH) - 2 bits as
    defined in Subclause 7.21 of [5, TS 38.213]
  - PUCCH resource indicator - 3 bits as defined in Subclausse 9.2.3 of [5, TS 38.213]
  - PDSCH-to-HARQ_feedback timing indicator - 3 bits as
    defined in Subclause 9.2.3 of [5, TS 38.213]
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

```
TABLE 7
      - Identifier for DCI formats - 1 bits
        - The value of this bit field is always set to 1, indicating, an DL DCI format
      - Carrier indicator - 0 or 3 bits, as defined in Subclause 10.1 of [5, TS 38.213].
      - Bandwidth part indicator - 0, 1 or 2 bits as determined by the number of DL BWPs
        n_{BWP,RRC} configured by higher layers, excluding the initial DL bandwidth part. The bitwidth for this field is
        determined as ┌log₂(n_{BWP})┐ bits, where
        - n_{BWP} = n_{BWP,RRC} + 1 if n_{BWP,RRC} ≤ 3, in which case the bandwidth part indicator is equivalent to the
          ascending order of the higher layer parameter BWP-Id;
        - otherwise n_{BWP} = n_{BWP,RRC}, in which case the bandwidth part indicator is defined in Table 7.3.1.1.2-1;
        If a UE does not support active BWP change via DCI, the UE ignores this bit field.
      - Frequency domain resource assignment - number of bits dermined by the
        $following where {N}_{RB}^{DL , BWP} is the size of the active DL bandwidth part :$
        - N_{RBG} bits if only resource allocation type 0 is configured, where N_{RBG} is defined in Subcaluse
          5.1.2.2.1 of [6, TS 38.214],
        $‐ ⌈ {log}_{2} ( {N}_{RB}^{UL , BWP} ( {N}_{RB}^{UL , BWP} + 1 ) / 2 ) ⌉ bits if only resource allocation type 1 is configured , or$
        $‐ max ( ⌈ {log}_{2} ( {N}_{RB}^{DL , BWP} ( {N}_{RB}^{DL , BWP} + 1 ) / 2 ) ⌉ , {N}_{RBG} ) + 1 bits if both resource allocation type 0 and 1 are$
          configured.
        - If both resource allocation type 0 and 1 are configured, the MSB bit is used to indicate resource
          allocation type 0 or resource allocation type 1, where the bit value of 0 indicates resource allocation type
          0 and the bit value of 1 indicates resource allocation type 1.
        - For resource allocation type 0, the N_{RBG} LSBs provide the resource allocation as defined in Subclause
          5.1.2.2.1 of [6, TS 38.214].
      $‐ For resource allocation type 1 , the ⌈ {log}_{2} ( {N}_{RB}^{DL , BWP} ( {N}_{RB}^{DL , BWP} + 1 ) / 2 ) ⌉ LSBs provide the resource$
        according as defined in Subclause 5.1.2.2.2 of [6, TS 38.214]
      If “Bandwidth part indicator” field indicates a bandwidth part other than the active bandwidth part and if
      both resource allocation type 0 and 1 are configured for the indicated bandwidth part, the UE assumes
      resource allocation type 0 for the indicated bandwidth part if the bitwidth of the “Frequency domain
      resource assignment” field of the active bandwidth part is smaller than the bitwidth of the “Frequency
      domain resource assignment” field of the indicated bandwidth part.
  - Time domain resource assignment - 0, 1, 2, 3, or 4 bits as defined in Subclause
      5.1.2.1 of [6, TS 38.214]. The bitwidth for this field is determined as ┌log₂(I)┐ bits, where I is the number of
      entries in the higher layer parameter pdsch-TimeDomainAllocationList if the higher layer parameter is
      configured; otherwise I is the number of entries in the default table.
  - VRB-to-PRB mapping (virtual resource block (VRB)-to-physical resource block (PRB)
        mapping) - 0 or 1 bit:
      - 0 bit if only resource allocation type 0 in configured or if interleaved VRB-to-PRB mapping is not
        configured by high layers;
      - 1 bit according to Table 7.3.1.2.2-5 otherwise, only applicable to resource allocation type 1, as defined in
        Subclause 7.3.1.6 of [4, TS 38.211].
  - PRB bundling size indiator - 0 bit if the higher layer parameter prb-
      BundlingType is not configured or is set to ‘static’, or 1 bit if the higher layer parameter prb-BundlingType is
      set to ‘dynamic’ according to Subclause 5.1.2.3 of [6, TS 38.214].
  - Rate matching indicator - 0, 1, or 2 bits according to higher layer parameters
      rateMatchPatternGroup1 and rateMatchPatternGroup2, where the MSB is used to indicate
      rateMatchPatternGroup1 and the LSB is used to indicate rateMatchPatternGroup2 when ther are two
      groups.
  - ZP CSI-RS trigger (zero power CSI-RS trigger) - 0, 1, or 2 bits as defined in Subclause
      5.1.4.2 of [6, TS 38.214]. The bitwidth for this field is determined as ┌log₂(n_{ZP} + 1)┐ bits, where n_{ZP} is
      the number of aperiodic ZP CSI-RS resource sets configured by higher layer.
  For transport block 1:
      - Modulation and coding scheme - 5 bits as defined in Subclause 5.1.3.1 of [6, TS
        38.214]
      - New data indicator - 1 bit
      - Redundancy version - 2 bits as defined in Table 7.3.1.1.1-2
  For transport block 2 (only present if maxNrofCodeWordsScheduleByDCI equal 2):
      - Modulation and coding scheme - 5 bits as defined in Subclause 5.1.3.1 of [6, TS
        38.214]
      - New data indicator - 1 bit
      - Redundancy version - 2 bits as defined in Table 7.3.1.1.1-2
      If “Bandwidth part indicator” field indicates a bandwidth part other than the active bandwidth part and the
      value of maxNrofCodeWordsScheduleByDCI for the indicated bandwidth part equals 2 and the value of
      maxNrofCodeWordsScheduleByDCI for the active bandwidth part equals 1, the UE assumes zeros are
      padded when interpreting the “Modulation and coding scheme”, “New data indicator”, and “Redundancy
      version” fields of transport block 2 according to Subclause 12 of [5, TS 38,213], and the UE ignores the
      “Modulation and coding scheme”, “New data indicator”, and “Redundancy version” fields of transport block
      2 for the indicated bandwidth part.
  - HARQ process number - 4 bits
  - Downlink assignment index - number of bits as defined in the following
      - 4 bits if more than one serving cell are configured in the DL and the higher layer parameter pdsch-
        HARQ-ACK-Codebook = dynamic, where the 2 MSB bits are the counter DAI and the 2 LSB bits are the
        total DAI:
      - 2 bits if only one serving cell is configured in the DL and the higher layer parameter pdsch-HARQ-ACK-
        Codebook = dynamic, where the 2 bits are the counter DAI:
      - 0 bits otherwise.
  - TPC command for scheduled PUCCH (transmit power control command for scheduled PUSCH) - 2 bits as
      defined in Subclause 7.2.1 of [5, TS 38.213]
  - PUCCH resource indicator - 3 bis as defined in Subclause 9.2.3 of [5, TS 38.213]
  - PDSCH-to-HARQ_feedback timing indicator - 0, 1, 2, or 3 bits as
      defined in Subclause 9.2.3 of [5, TS 38.213]. The bitwidth for this field is determined as ┌log₂(I)┐ bits,
      where I is the number of entries in the higher layer parameter all-DataToUL-ACK.
  - Antenna port(s) - 4, 5, or 6 bits as defined by Tables 7.3.122-1/2/3/4, where the number of
      CDM groups without data of values 1, 2, and 3 refers to CDM groups {0}, {0, 1}, and {0, 1, 2} respectively.
      The antenna ports {p₀ , ... , p₀₋₁} shall be determined according to the ordering of DMRS port(s) given by
      Tables 7.3.1.2.2-1/2/3/4.
      If a UE is configured with both dmrs-DownlinkForPDSCH-MappingTypeA and dmrs-DownlinkForPDSCH-
      MappingTypeB, the bitwidth of this field equals max{x_{A}, x_{B}}, where x_{A} is the “Antenna ports” bitwidth
      derived according to dmrs-DownlinkForPDSCH-MappingTypeA and x_{B} is the “Antenna ports” bitwidth
      derived according to dmrs-DownlinkForPDSCH-MappingTypeB. A number of |x_{A} − x_{B}| zeros are padded
      in the MSB of this field, if the mapping type of the PDSCH corresponds to the smaller value of x_{A} and x_{B}.
  - Transmission configuration indication - 0 bit if higher layer parameter tci-
      PresentInDCI is not enabled; otherwise 3 bits as defined in Subclause 5.1.5 of [6, TS 38.214]
      If “Bandwidth part indicator” field indicates a bandwidth part other than the active bandwidth part.
      - if the higher layer parameter tci-PresentInDCI is not enabled for the CORESET used for the PDCCH
        carrying the DCI format 1_1,
        - the UE assumes tci-PresentInDCI is not enabled for all CORESETs in the indicated bandwidth part;
      - otherwise.
        - the UE assumes tci-PresentInDCI is enabled for all CORESETs in the indicated bandwidth part;
  - SRS request - 2 bits as defined by Table 7.3.1.2.2-24 for UEs not configured with
      supplementaryUplink in ServingCellConfig in the cell; 3 bits for UEs configured with supplementaryUplink
      in ServingCallConfig in the cell where the first bit is the non-SUL/SUL indicator as defined in Table
      7.3.1.1.1-1 and the second and third bits are defined by Table 7.3.1.1.2-24. This bit field may also indicate
      the associated CSI-RS according to Subcaluse 6.1.1.2 of [6, TS 38.214].
  - code block group (CBG) transmission information (CBGTI) - 0 bit if higher layer parameter
      codeBlockGroupTransmission for PDSCH is not configured, otherwise, 2, 4, 6, or 8 bits as defined in
      Subclause 5.1.7 of [6, TS 38.214], determined by the higher layer parameters
      maxCodeBlockGroupPerTransportBlock and maxNrofCodeWordsScheduleByDCI for the PDSCH.
  - CBG flushing out information (CBGFI) - 1 bit if higher layer
      parameter codeBlockGroupFlushIndicator is configured as “TRUE”, 0 bit otherwise.
      DMRS sequence initialization - 1 bit.
```

### [PDCCH: CORESET, REG, CCE, and Search Space]

Hereinafter, a downlink control channel in a 5G wireless communication system will be described in more detail with reference to the accompanying drawings.

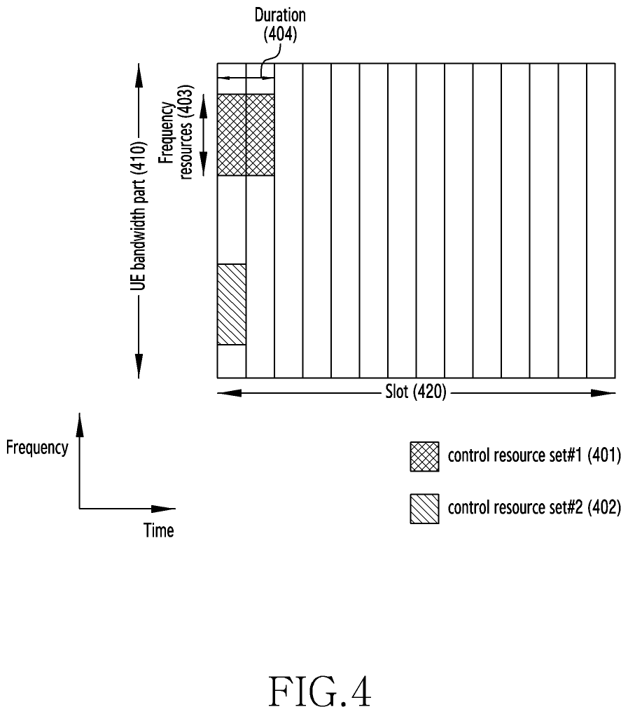

FIG. 4 illustrates an example of a control resource set (CORESET) used to transmit a downlink control channel in a 5G wireless communication system.

Referring to FIG. 4, a UE bandwidth part 410 may be configured along the frequency axis, and two control resource sets (control resource set #1 401 and control resource set #2 402) may be configured within one slot 420 along the time axis. The control resource sets 401 and 402 may be configured in a specific frequency resource 403 within the entire UE bandwidth part 420 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in the 5G wireless communication system as described above may be configured for a UE by a base station through upper layer signaling (for example, system information, MIB, RRC signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER |

(1..maxCoReSetDuration),
(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, |

n6},
(REG bundle size)

| | |
|---|---|
| precoderGranularity | ENUMERATED {sam |

eAsREG-bundle, allContiguousRBs},

| | |
|---|---|
| interleaverSize | ENUMERATED {n2, n3, |

n6}
(interleaver size)

| | |
|---|---|
| shiftIndex | INTEGER(0..maxNrofPh |
| ysicalResourceBlocks−1) | OPTIONAL |

```
        (interleaver shift)
      },
```

| | |
|---|---|
| nonInterleaved | NULL |

},

| | |
|---|---|
| tci-StatesPDCCH | SEQUENCE(SIZE (1..maxNr |
| ofTCI-StatesPDCCH)) OF TCI-StateId | OPTIONAL, |

(QCL configuration information)

| | |
|---|---|
| tci-PresentInDCI | ENUMERATED {enabled} |

```
                          OPTIONAL, ... Need S
  }
```

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (QCLed) with a DMRS transmitted in a corresponding control resource set.

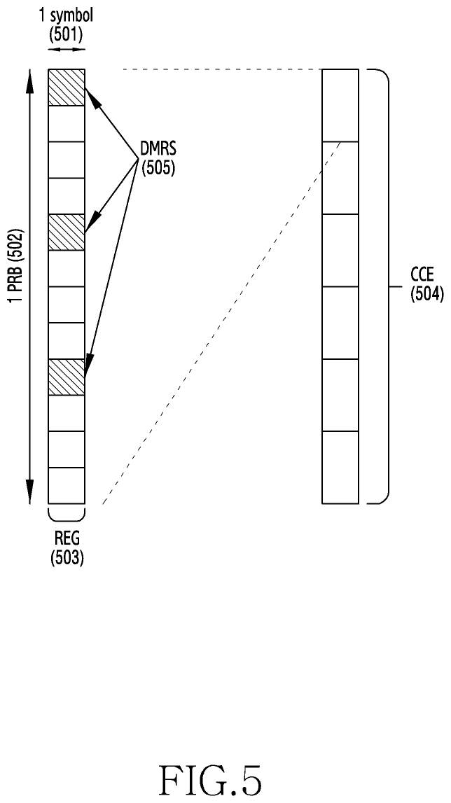

FIG. 5 illustrates a structure of a downlink control channel in a 5G wireless communication system.

That is, FIG. 5 illustrates an example of a basic unit of time and frequency resources constituting a downlink control channel available in a 5G wireless communication system.

According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in the 5G wireless communication system is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In the 5G wireless communication system, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, parameters of the search space for the PDCCH may include the following pieces of information given in Table 9 below.

TABLE 9

| | |
|---|---|
| SearchSpace ::= | SEQUENCE { |

```
      -- Identity of the search space. SearchSpaceId = 0 identifies the SearchSpace configured
  via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration (monitoring duration) | INTEGER (2..2559) |
| monitoringSymbolsWithinSlot | BIT STRING (SIZE (14)) |
| | OPTIONAL, |

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, |

n4, n5, n6, n8},

| | |
|---|---|
| aggregationLevel2 | ENUMERATED {n0, n1, n2, n3, |

n4, n5, n6, n8},

| | |
|---|---|
| aggregationLevel4 | ENUMERATED {n0, n1, n2, n3, |

n4, n5, n6, n8},

| | |
|---|---|
| aggregationLevel8 | ENUMERATED {n0, n1, n2, n3, |

n4, n5, n6, n8},

| | |
|---|---|
| aggregationLevel16 | ENUMERATED {n0, n1, n2, n3, |

```
      n4, n5, n6, n8}
            },
```

| | |
|---|---|
| searchSpaceType | CHOICE { |

```
            (search space type)
              -- Configures this search space as common search
      space (CSS) and DCI formats to monitor.
```

| | |
|---|---|
| common | SEQUENCE { |

```
            (common search space)
            }
```

| | |
|---|---|
| ue-Specific | SEQUENCE { |

```
            (UE-specific search space)
                -- Indicates whether the UE monitors in this USS for DCI formats 0-0
      and 1-0 or for formats 0-1 and 1-1.
```

| | |
|---|---|
| formats | ENUMERATED {formats0-0- |

```
      And-1-0, formats0-1-And-1-1},
            ...
      }
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, MCS-C-RNTI, SP-CSI-RNTI, RA-RNTI, TC-RNTI, P-RNTI, SI-RNTI DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI
Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
Enumerated RNTIs may follow the definition and usage given below
Cell RNTI (C-RNTI): used to schedule a UE-specific PDSCH
Modulation coding scheme (MCS)C-RNTI (MCS-C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS
The DCI formats enumerated above may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the |
| | PRB(s) and OFDM symbol(s) |
| | where UE may assume no transmission |
| | is intended for the UE |
| 2_2 | Transmission of TPC commands for |
| | PUCCH and PUSCH |
| 2_3 | Transmission of a group of TPC commands |
| | for SRS transmissions by one or more UEs |

In a 5G wireless communication system, the search space at aggregation level L in connection with CORESET p and search space set s may be expressed by the following equation.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{Cl}: carrier index
N_{CCE,p}: total number of CCEs existing in control resource set p

$${n}_{s , f}^{μ}$$

slot index

$${M}_{s , max}^{( L )}$$

number of PDCCH candidates at aggregation level L

$${m}_{s , {n}_{CI}} = 0 , … , {M}_{s , max}^{( L )} - 1$$

PDCCH candidate index at aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827 for pmod 3 = 0 ,$$

$${A}_{p} = 39829 for pmod 3 = 1 , {A}_{p} = 39839 for pmod 3 = 2 , D = 65537$$

n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

### [Regarding Uplink-Downlink Configuration]

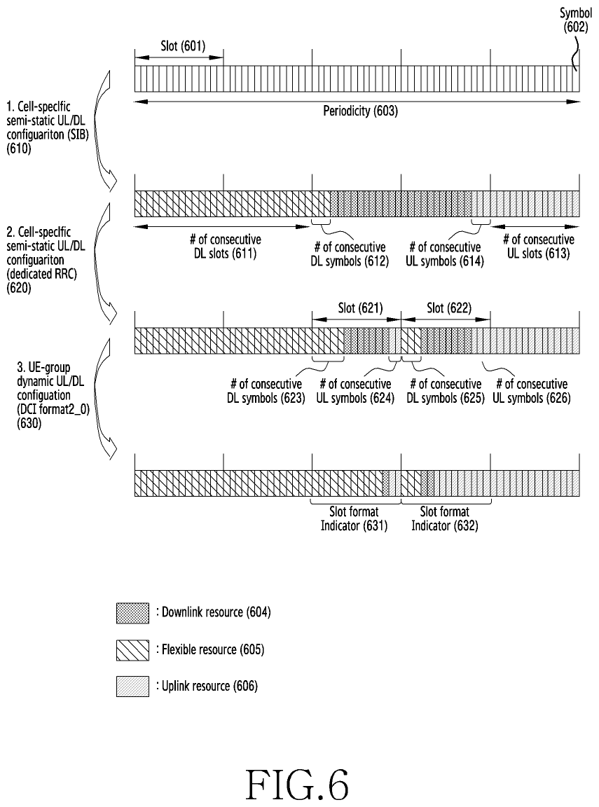

FIG. 6 illustrates an example of an uplink-downlink configuration considered in a 5G communication system according to an embodiment of the disclosure.

Referring to FIG. 6, a slot 601 may include 14 symbols 602. In a 5G communication system, an uplink-downlink configuration of symbols/slots may be performed in three steps. First, an uplink-downlink of symbols and/slots may be semi-statically configured through cell-specific configuration information 610 via system information in units of symbols. Specifically, the cell-specific uplink-downlink configuration information via the system information may include uplink-downlink pattern information and reference subcarrier information. The uplink-downlink pattern information may indicate a pattern periodicity, 603 the number 611 of consecutive downlink slots from the beginning of each pattern, the number 612 of symbols in the next slot, the number 613 of consecutive uplink slots from the end of the pattern, and the number 614 of symbols in the next slot. In regard of this, slots and symbols not indicated as uplink slots/symbols 606 or downlink slots/symbols 604 may be determined to be flexible slots/symbols 605.

Secondly, through user-specific configuration information 620 via dedicated higher layer signaling, flexible slots or slots 621 or 622 including flexible symbols may be each indicated by the number 623 or 625 of consecutive downlink symbols from the start symbol of the slot and the number 624 or 626 of consecutive uplink symbols from the end of the slot, or indicated as a downlink or uplink over the entire slot.

Finally, in order to dynamically change downlink signal transmission and uplink signal transmission intervals, whether symbols indicated as flexible symbols in each slot (i.e., symbols not indicated as a downlink and an uplink) are each a downlink symbol, an uplink symbols, or a flexible symbol may be indicated through a slot format indicator (SFI) 631 or 632 included in a downlink control channel 630. The slot format indicator may be selected as one index from a table in which an uplink-downlink configuration of 14 symbols in one slot is preconfigured as in Table 11 below.

TABLE 11

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot |
| | based on TDD-UL-DL-ConfigurationCommon, |
| | or TDD-UL-DL-ConfigDedicated and, |
| | if any, on detected DCI formats |

### [QCL, TCI State]

In a wireless communication system, one or more different antenna ports (which may also be replaced with one or more channels, signals, and combinations thereof, but will hereinafter be referred to as different antenna ports for convenience of description) may be associated with each other by a quasi co-location (QCL) configuration as in Table 12 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 12 below.

TABLE 12

| QCL type | Large-scale characteristics |
|---|---|
| A | Doppler shift, Doppler spread, average |
| | delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 13 below. Referring to Table 13, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) included in each TCI state includes the serving cell index and the BWP index of the reference RS indicated by the corresponding QCL information, the type and ID of the reference RS, and a QCL type as in Table 13 above.

TABLE 13

| | |
|---|---|
| TCI-State ::= | SEQUENCE |
| tci-StateId | TCI-StateId, |

(ID of corresponding TCI state)

| | |
|---|---|
| qcl-Type1 | QCL-Info, |

(QCL information of first refernece RS of RS (target RS) referring to
corresponding TCI state ID)

| | |
|---|---|
| qcl-Type2 | QCL-Info OPTIONAL, |

```
  -- Need R
  (QCL information of second refernece RS of RS (target RS) referring to
corresponding TCI state ID)
  ...
```

| | |
|---|---|
| QCL-Info ::= | SEQUENCE { |

```
  cell ServCellIndex OPTIONAL, -
- Need R
  (serving cell index of reference RS indicated by corresponding QCL
information)
```

| | |
|---|---|
| bwp-Id | BWP-Id |

```
  OPTIONAL, -- Cond CSI-RS-Indicated
  (BWP index of reference RS indicated by corresponding QCL information)
```

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL
information)
  },
```

| | |
|---|---|
| qcl-Type | ENUMERATED {typeA, typeB, typeC, |

typeD},
...
}

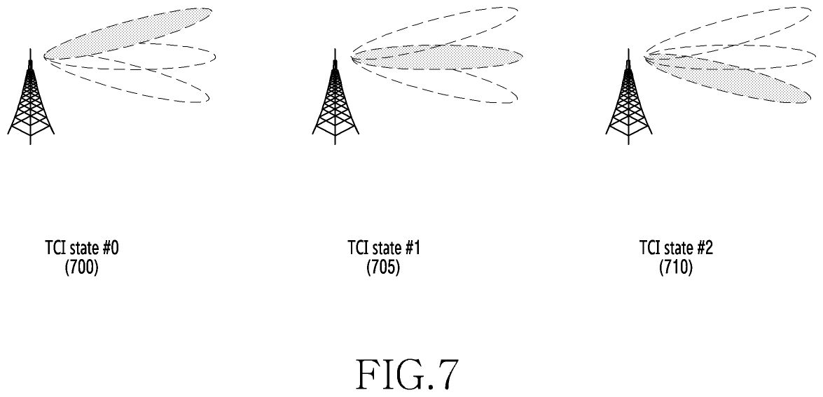

FIG. 7 illustrates an example of base station beam allocation according to TCI state configurations. Referring to FIG. 7, the base station may transfer information regarding N different beams to the UE through N different TCI states. For example, in the case of N=3 as in FIG. 4, the base station may configure qcl-Type2 parameters included in three TCI states 400, 405, and 410 in QCL type D while being associated with CSI-RSs or SSBs corresponding to different beams, thereby notifying that antenna ports referring to the different TCI states 400, 405, and 410 are associated with different spatial Rx parameters, that is, different beams.

Tables 14-1 to 14-5 below enumerate valid TCI state configurations according to the target antenna port type.

Table 14-1 enumerates valid TCI state configurations when the target antenna port is a CSI-RS for tracking (i.e., tracking reference signal (TRS)). The TRS refers to an NZP CSI-RS which has no repetition parameter configured therefor, and trs-Info of which is configured as “true”, among CRI-RSs. In Table 14-1, configuration no. 3 may be used for an aperiodic TRS.

TABLE 14-1
Valid TCI state configurations when the target antenna
port is a CSI-RS for tracking (TRS)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL- | SSB | QCL-TypeD |
| | | TypeC | | |
| 2 | SSB | QCL- | CSI-RS (BM) | QCL-TypeD |
| | | TypeC | | |
| 3 | TRS | QCL- | TRS (same as | QCL-TypeD |
| | (periodic) | TypeA | DL RS 1) | |

Table 14-2 enumerates valid TCI state configurations when the target antenna port is a CSI-RS for CSI. The CSI-RS for CSI refers to an NZP CSI-RS which has no parameter indicating repetition (for example, repetition parameter) configured therefor, and trs-Info of which is not configured as “true”, among CRI-RSs.

TABLE 14-2
Valid TCI state configurations when the target
antenna port is a CSI-RS for CSI

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL- | SSB | QCL-TypeD |
| | | TypeA | | |
| 2 | TRS | QCL- | CSI-RS for | QCL-TypeD |
| | | TypeA | BM | |
| 3 | TRS | QCL- | TRS (same as | QCL-TypeD |
| | | TypeA | DL RS 1) | |
| 4 | TRS | QCL-TypeB | | |

Table 14-3 enumerates valid TCI state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs.

TABLE 14-3
Valid TCI state configurations when the target antenna
port is a CSI-RS for BM (for L1 RSRP reporting)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL- | TRS (same as | QCL-TypeD |
| | | TypeA | DL RS 1) | |
| 2 | TRS | QCL- | CSI-RS (BM) | QCL-TypeD |
| | | TypeA | | |
| 3 | SS/PBCH | QCL- | SS/PBCH | QCL-TypeD |
| | Block | TypeC | Block | |

Table 14-4 enumerates valid TCI state configurations when the target antenna port is a PDCCH DMRS.

TABLE 14-4
Valid TCI state configurations when the target antenna
port is a PDCCH DMRS

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL- | TRS (same as | QCL-TypeD |
| | | TypeA | DL RS 1) | |
| 2 | TRS | QCL- | CSI-RS (BM) | QCL-TypeD |
| | | TypeA | | |
| 3 | CSI-RS | QCL- | CSI-RS (same | QCL-TypeD |
| | (CSI) | TypeA | as DL RS 1) | |

Table 14-5 enumerates valid TCI state configurations when the target antenna port is a PDSCH DMRS.

TABLE 14-5
Valid TCI state configurations when the target antenna
port is a PDSCH DMRS

| Valid TCI | | qcl- | DL RS 2 | qcl-Type2 |
|---|---|---|---|---|
| state | DL | Type | (If | (If |
| Configuration | RS 1 | 1 | configured) | configured) |
| 1 | TRS | QCL- | TRS | QCL- |
| | | Type | | TypeD |
| | | A | | |
| 2 | TRS | QCL- | CSI-RS | QCL- |
| | | Type | (BM) | TypeD |
| | | A | | |
| 3 | CSI- | QCL- | CSI-RS | QCL- |
| | RS | Type | (CSI) | TypeD |
| | (CSI) | A | | |

According to a representative QCL configuration method based on Tables 14-1 to 14-5 above, the target antenna port and reference antenna port for each step are configured and operated such as “SSB”-> “TRS”-> “CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 14 below. The fourth row in Table 14 corresponds to a combination assumed by the UE before RRC configuration, and no configuration is possible after the RRC.

TABLE 15

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS (CSI) | QCL- | | |
| | | TypeA | | |
| 4 | SS/PBCH | QCL- | SS/PBCH | QCL-TypeD |
| | Block | TypeA | Block | |

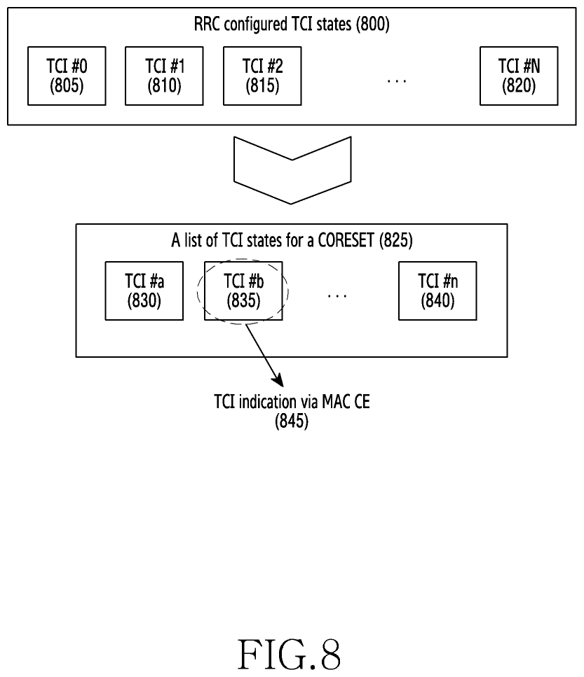

In NR, a hierarchical signaling method as illustrated in FIG. 8 is supported for dynamic allocation regarding a PDCCH beam. Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

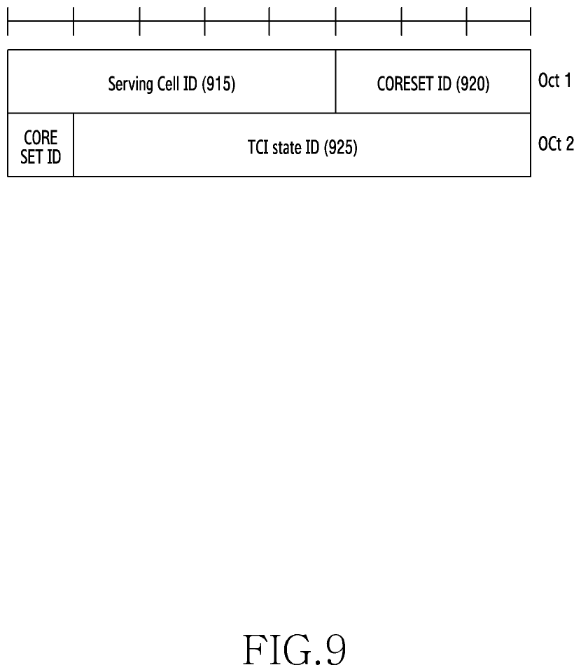

FIG. 9 illustrates a TCI indication MAC CE signaling structure for the PDCCH DMRS. Referring to FIG. 9, the TCI indication MAC CE signaling for the PDCCH DMRS may be configured by 2 bytes (16bits), and include a 5-bit serving cell ID 915, a 4-bit CORESET ID 920, and a 7-bit TCI state ID 925.

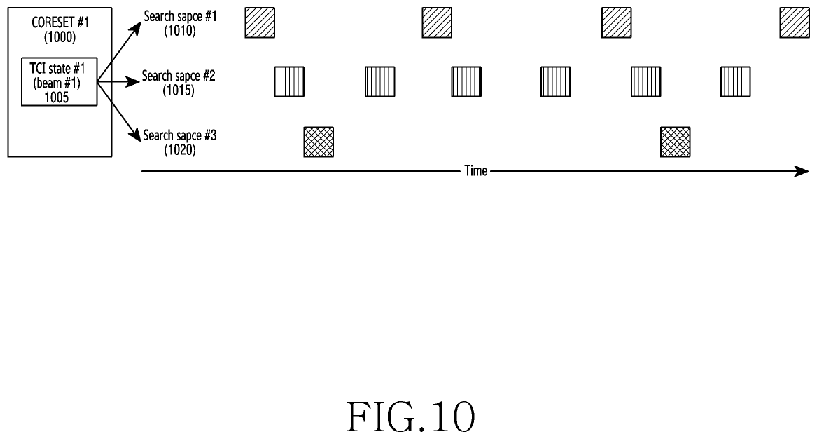

FIG. 10 illustrates an example of a beam configuration with regard to a control resource set (CORESET) and a search space according to the above description. Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding CORESET, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in CORESET #Ohas been QCL-ed with a SS/PBCH block identified in the initial access process, or in a non-contention-based random access process not triggered by a PDCCH command.

With regard to a control resource set having a configured index value other than 0 (control resource set #X), if the UE has no TCI state configured regarding control resource set #X, or if the UE has one or more TCI states configured therefor but has failed to receive a MAC CE activation command for activating one thereof, the UE may assume that the DMRS transmitted in control resource set #×has been QCL-ed with a SS/PBCH block identified in the initial access process.

### [PDCCH: Regarding QCL Prioritization Rule]

Hereinafter, operations for determining QCL priority regarding a PDCCH will be described in detail.

If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.
Criterion 1: A control resource set connected to a common search space having the lowest index inside a cell corresponding to the lowest index among cells including a common search space
Criterion 2: A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

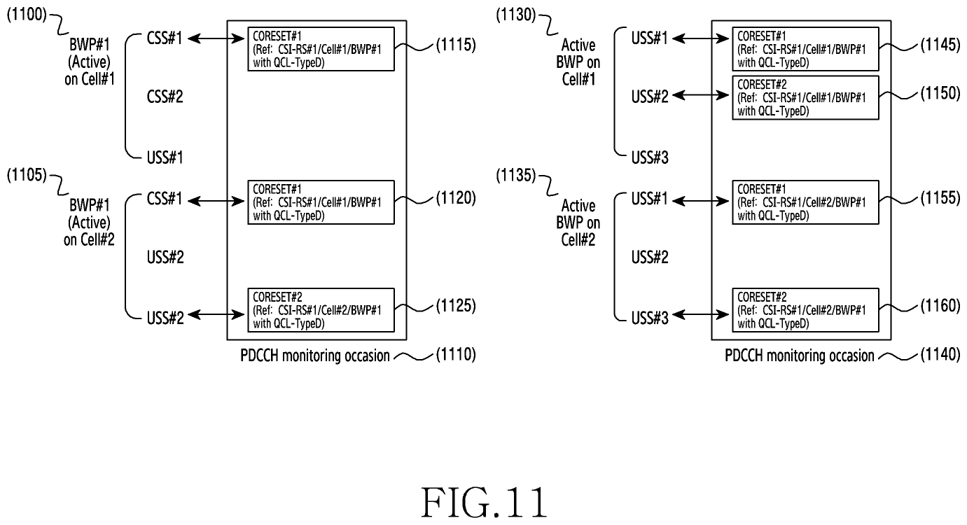

FIG. 11 illustrates a method in which, upon receiving a downlink control channel, a UE selects a receivable control resource set in consideration of priority in a wireless communication system according to an embodiment of the disclosure. As an example, the UE may be configured to receive multiple control resource sets overlapping temporally in a specific PDCCH monitoring occasion 1110, and such multiple control resource sets may be connected to a common search space (CSS) or a UE-specific search space (USS) with regard to multiple cells. In the corresponding PDCCH monitoring occasion, control resource set no. 1 1100 connected to common search space no. 1 may exist in bandwidth part no. 1 1115 of cell no. 1, and control resource set no. 1 1105 connected to common search space no. 1 and control resource set no. 2 1120 connected to UE-specific search space no. 2 may exist in bandwidth part no. 1 1125 of cell no. 2. The control resource sets 1115 and 1120 may have a relation of QCL-TypeD with CSI-RS resource no. 1 configured in bandwidth part no. 1 of cell no. 1, and the control resource set 1125 may have a relation of QCL-TypeD with CSI-RS resource no. 1 configured in bandwidth part no. 1 of cell no. 2. If criterion 1 is applied to the corresponding PDCCH monitoring occasion 1110, all other control resource sets having the same reference signal of QCL-TypeD as control resource set no. 1 1115 may be received. Therefore, the UE may receive the control resource sets 1110 and 1115 in the corresponding PDCCH monitoring occasion 1120.

As another example, the UE may be configured to receive multiple control resource sets overlapping temporally in a specific PDCCH monitoring occasion 1140, and such multiple control resource sets may be connected to a common search space or a UE-specific search space with regard to multiple cells. In the corresponding PDCCH monitoring occasion, control resource set no. 1 1130 connected to UE-specific search space no. 1 and control resource set no. 2 1145 connected to UE-specific search space no. 2 may exist in bandwidth part no. 1 1150 of cell no. 1, and control resource set no. 1 1135 connected to UE-specific search space no. 1 and control resource set no. 2 1155 connected to UE-specific search space no. 3 may exist in bandwidth part no. 1 1160 of cell no. 2. The control resource sets 1145 and 1150 may have a relation of QCL-TypeD with CSI-RS resource no. 1 configured in bandwidth part no. 1 of cell no. 1, the control resource set 1155 may have a relation of QCL-TypeD with CSI-RS resource no. 1 configured in bandwidth part no. 1 of cell no. 2, and the control resource set 1160 may have a relation of QCL-TypeD with CSI-RS resource no. 2 configured in bandwidth part no. 1 of cell no. 2. If criterion 1 is applied to the corresponding PDCCH monitoring occasion 1140, there is no common search space, and the next criterion, that is, criterion 2, may thus be applied. If criterion 2 is applied to the corresponding PDCCH monitoring occasion 1140, all other control resource sets having the same reference signal of QCL-TypeD as control resource set no. 1 1145 may be received. Therefore, the UE may receive the control resource sets 1140 and 1145 in the corresponding PDCCH monitoring occasion 1150.

### [PDSCH: Regarding Frequency Resource Allocation]

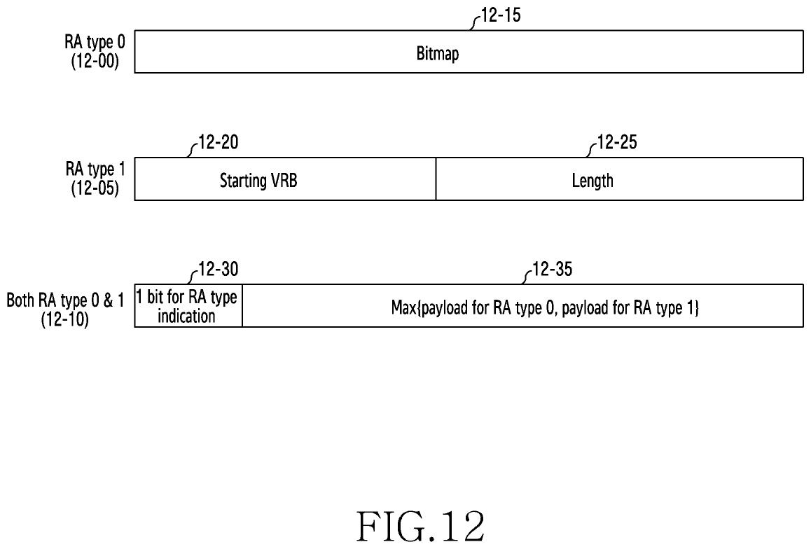

FIG. 12 illustrates an example of frequency domain resource allocation with regard to a PDSCH in a wireless communication system according to an embodiment of the disclosure.

FIG. 12 illustrates three frequency domain resource allocation methods of type 0 12-00, type 1 12-01, and dynamic switch 12-10 which can be configured through an upper layer in an NR wireless communication system.

Referring to FIG. 12, in the case in which a UE is configured to use only resource type 0 through upper layer signaling (12-00), partial downlink control information (DCI) for allocating a PDSCH to the UE include a bitmap including NRBG bits. The conditions for this will be described again later. As used herein, NRBG refers to the number of resource block groups (RBGs) determined according to the BWP size allocated by a BWP indicator and upper layer parameter rbg-Size, as in Table 16 below, and data is transmitted in RBGs indicated as “1” by the bitmap.

TABLE 16

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case in which the UE is configured to use only resource type 1 through upper layer signaling (12-05), partial DCI includes frequency domain resource allocation information including

$$[ {log}_{2} ( {N}_{R B}^{DL , BWP} ( {N}_{R B}^{DL , BWP} + 1 ) / 2 ] bits .$$

The conditions for this will be described again later. The base station may thereby configure a starting VRB 12-20 and the length 12-25 of a frequency domain resource allocated continuously therefrom.

In the case in which the UE is configured to use both resource type 0 and resource type 1 through upper layer signaling (12-10), partial DCI for allocating a PDSCH to the corresponding UE includes frequency domain resource allocation information including as many bits as the larger value 12-35 between the payload 12-15 for configuring resource type 0 and the payload 12-20 and 12-25 for configuring resource type 1. The conditions for this will be described again later. One bit may be added to the foremost part (MSB) of the frequency domain resource allocation information inside the DCI, and if the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a 5G wireless communication system will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. The time domain resource allocation information may include PDCCH-to-PDSCH slot timing (for example, corresponding to a slot-unit time interval between a time point at which a PDCCH is received and a time point at which a PDSCH scheduled by the received PDCCH is transmitted; labeled K0), PDCCH-to-PUSCH slot timing (for example, corresponding to a slot-unit time interval between a time point at which a PDCCH is received and a time point at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 17 or Table 18 below may be transmitted from the base station to the UE.

TABLE 17
PDSCH-TimeDomainResourceAllocationList information element

```
  PDSCH-TimeDomainResourceAllocationList ::= SEQUENCE (SIZE(1..maxNrofDL-
Allocations)) OF
  PDSCH-TimeDomainResourceAllocation
```

| | |
|---|---|
| PDSCH-TimeDomainResourceAllocation ::= | SEQUENCE { |

```
        k0
INTEGER(0..32)
  OPTIONAL, -- Need S
      (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 18
PUSCH-TimeDomainResourceAllocationList information element

```
  PUSCH-TimeDomainResourceAllocationList ::= SEQUENCE (SIZE(1..maxNrofUL-
Allocations)) OF
  PUSCH-TimeDomainResourceAllocation
```

| | |
|---|---|
| PUSCH-TimeDomainResourceAllocation ::= | SEQUENCE { |
| k2 | INTEGER(0..32) OPTIONAL, -- |

Need S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

Hereinafter, a method of allocating frequency domain resources for a data channel in a 5G wireless communication system will be described.

5G wireless communication systems support two types including resource allocation type 0 and resource allocation type 1, as a method of indicating frequency domain resource allocation information for a downlink data channel (a physical downlink shared channel (PDSCH)) and an uplink data channel (a physical uplink shared channel (PUSCH)).

### [Resource Allocation Type 0]

RB allocation information may be notified of from a base station to a UE in a type of a bitmap for a resource block group (RBG). The RBG may be configured by a set of consecutive virtual RBs (VRBs), and the size P of the RBG may be determined based on a value configured by a higher layer parameter (rbg-Size) and the size of a bandwidth part defined in table below.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number (NRBG) of RBGs of bandwidth part i having a size of

$${N}_{BWP , i}^{size}$$

may be dennea as in Table 19-1 below.

```
TABLE 19-1
  ▪  ${N}_{RBG} = ⌈ ( {N}_{BWP , i}^{size} + ( {N}_{BWP , i}^{start} mod P ) ) / P ⌉ , where$
    ♦  $the size of the first RBG is {RBG}_{0}^{size} = P - {N}_{BWP , i}^{start} mod P ,$
    ♦  $the size of last RBG is {RBG}_{last}^{size} = ( {N}_{BWP , i}^{start} + {N}_{BWP , i}^{size} ) mod P if ( {N}_{BWP , i}^{start} + {N}_{BWP , i}^{size} ) mod P > 0 and P otherwise ,$
    ♦ the size of all other RBGs is P.
```

Each bit of a bitmap having a size of N_{RBG} bits may correspond to a corresponding RBG. RBGs may be assigned indexes according to a sequence in which the frequency increases from the lowest frequency position of a bandwidth part. With respect to N_{RBG} RBGs in a bandwidth part, RBG #0 to RBG #(N_{RBG}−1) may be mapped from the MSB to the LSB of a RBG bitmap. In case that a particular bit value in a bitmap is 1, a UE may determine that an RBG corresponding to the bit value has been allocated, and in case that a particular bit value in a bitmap is 0, the UE may determine that an RBG corresponding to the bit value has not been allocated.

### [Resource Allocation Type 1]

RB allocation information may be notified of from a base station to a UE as information on the start position and length of consecutively allocated VRBs. Interleaving or non-interleaving may be additionally applied to the consecutively allocated VRBs. A resource allocation field of resource allocation type 1 may be configured by a resource indication value (RIV), and the RIV may be configured by the start point (RBₛₜₐᵣₜ) of a VRB and the length (L_{RBS}) of consecutively allocated RBs. More specifically, an RIV of a bandwidth part having a size of

$${N}_{BWP}^{size}$$

may be defined as in Table 19-2 below.

```
TABLE 19-2
  ▪  $if ( {L}_{RBs} - 1 ) \leq ⌊ {N}_{BWP}^{size} / 2 ⌋ then$
    ♦  $RIV = {N}_{BWP}^{size} ( {L}_{RB} - 1 ) + {RB}_{start}$
  ▪ else
    ♦  $RIV = {N}_{BWP}^{size} ( {N}_{BWP}^{size} - {L}_{RB} + 1 ) + ( {N}_{BWP}^{size} - 1 - {RB}_{start} )$
  ▪  $where {L}_{RBs} \geq 1 and shall not exceed {N}_{BWP}^{size} - {RB}_{start} .$
```

A base station may configure, for a UE, a resource allocation type through higher layer signaling (e.g., the higher layer parameter resourceAllocation may be configured to have one value among resourceAllocation Type0, resourceAllocationType1, or dynamicSwitch). If both resource allocation types 0 and 1 are both configured for the UE (or in the same way, the higher layer parameter resourceAllocation is configured to be dynamicSwitch), the base station may indicate whether a bit corresponding to the most significant bit (MSB) in a field indicating resource allocation in a DCI format indicating scheduling corresponds resource allocation type 0 or 1. In addition, resource allocation information may be indicated through the remaining bits except for the bit corresponding to the MSB, based on the indicated resource allocation type, and the UE may interpret resource allocation field information of a DCI field, based on the resource allocation information. If one of resource allocation type 0 or 1 is configured for the UE (or in the same way, the higher layer parameter resourceAllocation is configured to be resourceAllocationType0 or resourceAllocationType1), a field indicating resource allocation in a DCI format indicating scheduling may indicate resource allocation information, based on the configured resource allocation type, and the UE may interpret resource allocation field information of a DCI field, based on the resource allocation information.

### [PDSCH: TCI State Activation MAC-CE]

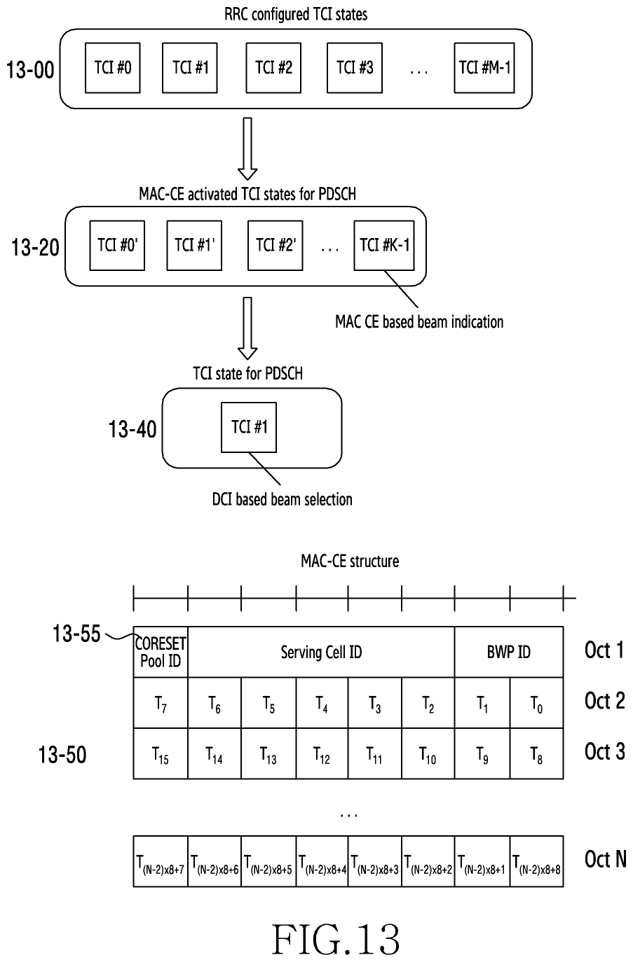

Next, a method for beam configuration with regard to a PDSCH will be described. FIG. 13 illustrates an example of a process for a beam configuration and activation with regard to a PDSCH. A list of TCI states regarding a PDSCH may be indicated through an upper layer list such as RRC (13-00). The list of TCI states may be indicated by tci-StatesToAddModList and/or tci-StatesToReleaseList inside a BWP-specific PDSCH-Config IE, for example. Next, a part of the list of TCI states may be activated through a MAC-CE (13-20). Next, some of the TCI states activated through the MAC-CE may be selected (13-40). The maximum number of activated TCI states may be determined by the capability reported by the UE. (13-50) illustrates an example of an MAC-CE structure for PDSCH TCI state activation/deactivation.

The meaning of respective fields inside the MAC CE and values configurable for respective fields are as follows.
Serving Cell ID (serving cell identity): This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID (bandwidth part identity): This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Ti (TCI state identity): If there is a TCI state with TCI-StateId i as specified in TS 38.331 [5], this field indicates the activation/deactivation status of the TCI state with TCI-StateId i, otherwise MAC entity shall ignore the Ti field. The Ti field is set to 1 to indicate that the TCI state with TCI-StateId i shall be activated and mapped to the codepoint of the DCI Transmission Configuration Indication field, as specified in TS 38.214 [7]. The Ti field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1 and so on. The maximum number of activated TCI states is 8;
CORESET Pool ID (13-55): This field indicates that mapping between the activated TCI states and the codepoint of the DCI Transmission Configuration Indication set by field Ti is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORESET Pool ID field shall be ignored when receiving the MAC CE.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1PUSCH transmission may be configured semi-statically by receiving configuredGrantConfig including rrc-ConfiguredUplinkGrant in Table 20 through upper signaling, without receiving a UL grant inside DCI. Configured grant Type 2PUSCH transmission may be scheduled semi-persistently by a UL grant inside DCI after receiving configuredGrantConfig not including rrc-ConfiguredUplinkGrant in Table 0 through upper signaling. If PUSCH transmission is operated by a configured grant, parameters applied to the PUSCH transmission are applied through configuredGrantConfig (upper signaling) in Table 20 except for dataScramblingIdentityPUSCH, txConfig, codebookSubset, maxRank, and scaling of UCI-OnPUSCH, which are provided by pusch-Config (upper signaling) in Table 21. If provided with transformPrecoder inside configuredGrantConfig (upper signaling) in Table 20, the UE applies tp-pi2BPSK inside pusch-Config in Table 21 to PUSCH transmission operated by a configured grant.

```
TABLE 20
ConfiguredGrantConfig ::=  SEQUENCE {
  frequencyHopping ENUMERATED {intraSlot, interSlot}
OPTIONAL,  -- Need S,
  cg-DMRS-Configuration  DMRS-UplinkConfig,
  mcs-Table  ENUMERATED {qam256, qam64LowSE}
OPTIONAL,  -- Need S
  mcs-TableTransformPrecoder ENUMERATED {qam256, qam64LowSE}
OPTIONAL,  -- Need S
  uci-OnPUSCH  SetupRelease { CG-UCI-OnPUSCH }
OPTIONAL,  -- Need M
  resourceAllocation ENUMERATED { resourceAllocationType0,
resourceAllocationType1, dynamicSwitch },
  rbg-Size ENUMERATED {config2}
OPTIONAL,  -- Need S
  powerControlLoopToUse  ENUMERATED {n0, n1},
  p0-PUSCH-Alpha P0-PUSCH-AlphaSetId,
  transformPrecoder  ENUMERATED {enabled, disabled}
OPTIONAL,  -- Need S
  nrofHARQ-Processes INTEGER(1..16),
  repK ENUMERATED {n1, n2, n4, n8},
  repK-RV  ENUMERATED {s1-0231, s2-0303, s3-0000}
OPTIONAL,  -- Need R
  periodicity  ENUMERATED {
                        sym2, sym7, sym1x14, sym2x14, sym4x14,
sym5x14, sym8x14, sym10x14, sym16x14, sym20x14,
                        sym32x14, sym40x14, sym64x14, sym80x14,
sym128x14, sym160x14, sym256x14, sym320x14, sym512x14,
                        sym640x14, sym1024x14, sym1280x14,
sym2560x14, sym5120x14,
                        sym6, sym1x12, sym2x12, sym4x12, sym5x12,
sym8x12, sym10x12, sym16x12, sym20x12, sym32x12,
                        sym40x12, sym64x12, sym80x12, sym128x12,
sym160x12, sym256x12, sym320x12, sym512x12, sym640x12,
                        sym1280x12, sym2560x12
  },
  configuredGrantTimer INTEGER (1..64)
OPTIONAL,  -- Need R
  rrc-ConfiguredUplinkGrant  SEQUENCE {
    timeDomainOffset INTEGER (0..5119),
    timeDomainAllocation INTEGER (0..15),
    frequencyDomainAllocation  BIT STRING (SIZE(18)),
    antennaPort  INTEGER (0..31),
    dmrs-SeqInitialization INTEGER (0..1)
OPTIONAL,  -- Need R
    precodingAndNumberOfLayers INTEGER (0..63),
    srs-ResourceIndicator  INTEGER (0..15)
OPTIONAL,  -- Need R
    mcsAndTBS  INTEGER (0..31),
    frequencyHoppingOffset INTEGER (1..
maxNrofPhysicalResourceBlocks-1) OPTIONAL,  -- Need R
    pathlossReferenceIndex INTEGER (0..maxNrofPUSCH-
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 21, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 21, the UE does not expect scheduling through DCI format 0_1.

```
TABLE 21
PUSCH-Config ::= SEQUENCE {
  dataScramblingIdentityPUSCH  INTEGER (0..1023)
OPTIONAL,  -- Need S
  txConfig ENUMERATED {codebook,
nonCodebook} OPTIONAL,  -- Need S
  dmrs-UplinkForPUSCH-MappingTypeA SetupRelease { DMRS-
UplinkConfig } OPTIONAL,  -- Need M
  dmrs-UplinkForPUSCH-MappingTypeB SetupRelease { DMRS-
UplinkConfig } OPTIONAL,  -- Need M
  pusch-PowerControl PUSCH-PowerControl
OPTIONAL,  -- Need M
  frequencyHopping ENUMERATED {intraSlot, interSlot}
OPTIONAL,  -- Need S
  frequencyHoppingOffsetLists  SEQUENCE (SIZE (1..4)) OF INTEGER
(1.. maxNrofPhysicalResourceBlocks−1)
OPTIONAL,  -- Need M
  resourceAllocation ENUMERATED { resourceAllocationType0,
resourceAllocationType1, dynamicSwitch},
  pusch-TimeDomainAllocationList SetupRelease { PUSCH-
TimeDomainResourceAllocationList }  OPTIONAL,  -- Need M
  pusch-AggregationFactor  ENUMERATED { n2, n4, n8 }
OPTIONAL,  -- Need S
  mcs-Table  ENUMERATED {qam256, qam64LowSE}
OPTIONAL,  -- Need S
  mcs-TableTransformPrecoder ENUMERATED {qam256, qam64LowSE}
OPTIONAL,  -- Need S
  transformPrecoder  ENUMERATED {enabled, disabled}
OPTIONAL,  -- Need S
  codebookSubset ENUMERATED
{fullyAndPartialAndNonCoherent, partialAndNonCoherent,nonCoherent}
OPTIONAL, -- Cond codebookBased
  maxRank  INTEGER (1..4)
OPTIONAL, -- Cond codebookBased
  rbg-Size ENUMERATED { config2}
OPTIONAL, -- Need S
  uci-OnPUSCH  SetupRelease { UCI-OnPUSCH}
OPTIONAL, -- Need M
  tp-pi2BPSK ENUMERATED {enabled}
OPTIONAL, -- Need S
  ...
}
```

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “nonCoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. In NR, a PUSCH preparation procedure time has been defined in consideration of this. The PUSCH preparation procedure time of the UE may follow Equation 2 given below.

$${T}_{proc , 2} = max ( ( {N}_{2} + {d}_{2 , 1} + {d}_{2} ) ( 2048 + 1 \; 44 ) κ {2}^{- μ} {T}_{c} + {T}_{ext} + {T}_{switch} , {d}_{2 , 2} ) \qquad Equation 2$$

Each parameter in T_{proc,2} described above may have the following meaning.
N₂: the number of symbols determined according to UE processing capability 1 or 2, based on the UE's capability, and numerology μ. N₂ may have a value in Table 22 if UE processing capability 1 is reported according to the UE's capability report, and may have a value in Table 23 if UE processing capability 2 is reported, and if availability of UE processing capability 2 is configured through upper layer signaling.

TABLE 22

| μ | PUSCH preparation time N₂ [symbols] |
|---|---|
| 0 | 10 |
| 1 | 12 |
| 2 | 23 |
| 3 | 36 |

TABLE 23

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.

$${T}_{c} \text{:} has 1 / ( Δ {f}_{max} \cdot {N}_{f} ) , Δ {f}_{max} = 480 \cdot {10}^{3} Hz , {N}_{f} = 4096 . .$$

d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, Tswitch is assumed to be 0.

The base station and the UE may determine that the PUSCH preparation procedure time is insufficient if the first symbol of a PUSCH starts earlier than the first uplink symbol in which a CP starts after T_{proc,2} from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

Next, PUSCH repetition transmission will be described. If higher layer signaling pusch-AggregationFactor is configured for a UE when PUSCH transmission is scheduled for the UE via DCI format 0_1 within a PDCCH including a CRC scrambled by C-RNTI, MCS-C-RNTI, or CS-RNTI, the same symbol allocation is applied in as many consecutive slots as the pusch-AggregationFactor, and the PUSCH transmission is limited to single rank transmission. For example, the UE needs to repeat the same TB in as many consecutive slots as the pusch-AggregationFactor, and apply the same symbol allocation for each slot. Table 24 enumerates a redundancy version to be applied to PUSCH repetition transmission for each slot. If PUSCH repetition transmission in multiple slots is indicated for the UE by DCI format 0_1, and at least one symbol in slots in which PUSCH repetition transmission is performed is indicated as a downlink symbol according to information of higher layer signaling tdd-UL-DL-ConfigurationCommon or tdd-UL-DL-ConfigurationDedicated, the UE does not perform PUSCH transmission in the slot in which the corresponding symbol is located.

TABLE 24

| rv_{id} indicated | | | | |
|---|---|---|---|---|
| by the DCI | rv_{id} to be applied to n^{th} transmission occasion | | | |
| scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through upper layer signaling.

### [PUSCH Repetition Type a Transmission (PUSCH Repetition Type A)]

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
The UE may perform repetition transmission of the same uplink data channel in consecutive slots in a repetition transmission interval which is identified based on the length of the uplink data channel configured based on the start symbol and the number of repetition transmissions. If, in the repetition transmission interval, there is a slot configured as a downlink for the UE by the base station or at least one symbol configured as a downlink among symbols of the uplink data channel configured for the UE, the UE omits transmission of the uplink data channel but counts the number of repetition transmissions of the uplink data channel in the corresponding slot or symbol.

### [PUSCH Repetition Type B Transmission (PUSCH Repetition Type B)]

As described above, the symbol length of an uplink data channel and the location of the start symbol may be determined by a time domain resource allocation method in one slot, and a base station may notify a UE of the number of repetition transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

In this regard, n=0, . . . , numberofrepetitions-1, S refers to the start symbol of the configured uplink data channel, and L refers to the symbol length of the configured uplink data channel. Ks refers to the slot in which PUSCH transmission starts, and

$${N}_{symb}^{slot}$$

refers to the number or symbols per slot.
The UE may determine invalid symbols for PUSCH repetition type B transmission.
1. A symbol configured as a downlink by tdd-UL-DL-ConfigurationCommon or tdd-UL-DL-ConfigurationDedicated may be determined as the invalid symbol for PUSCH repetition type B transmission.
2. In order to receive an SSB in an unpaired spectrum (TDD spectrum), symbols indicated by ssb-PositionInBurst within SIB1 or ssb-PositionInBurst within ServingCellConfigCommon (upper layer signaling) may be determined as invalid symbols for PUSCH repetition type B transmission.
3. In order to transmit a control resource set associated with a Type0-PDCCH CSS set in an unpaired spectrum (TDD spectrum), symbols indicated through by pdsch-ConfigSIB 1 within an MIB may be determined as invalid symbols for PUSCH repetition type B transmission.
4. In an unpaired spectrum (TDD spectrum), if numberOfInvalidSymbolsForDL-UL-Switching (upper layer signaling) is configured, as many symbols as numberOfInvalidSymbolsForDL-UL-Switching from symbols configured as a downlink by tdd-UL-DL-ConfigurationCommon or tdd-UL-DL-ConfigurationDedicated may be determined as invalid symbols.
Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot. In the case where the OFDM symbol length of the nominal repetition is not 1, if the length of the actual repetition is 1, the UE may ignore transmission for the actual repetition.

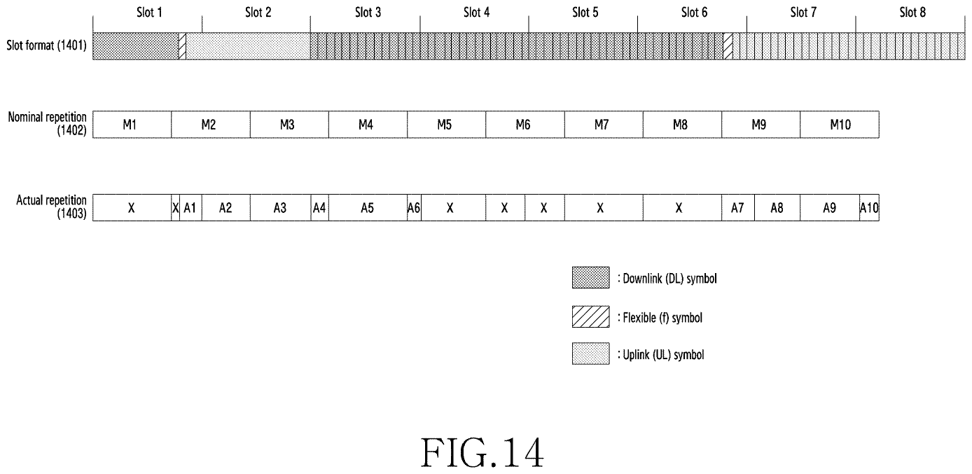

FIG. 14 illustrates an example of PUSCH repetition type B transmission according to an embodiment of the disclosure.

FIG. 14 exemplifies a case where, for nominal repetitions, a start symbol S of 0, a transmission symbol length L of 10, and a number of repetitions of 16 are configured for the UE, which may be represented by N1 to N10 in the drawing (1402). In this case, the UE may determine actual repetitions by determining invalid symbols in consideration of the slot format 1401, which may be represented by A1 to A10 in the drawing (1403). According to the invalid symbol and actual repetition determination scheme as described above, PUSCH repetition type B is not transmitted in symbols the slot format of which is determined as a downlink (DL), and if a slot boundary exists in a nominal repetition, the nominal repetition may be divided into two actual repetitions with respect to the slot boundary and the divided actual repetitions may be transmitted. As an example, A1 denoting the first actual repetition may include 3 OFDM symbols, and subsequently transmittable A2 may include 6 OFDM symbols.

In regard to the PUSCH repetition transmission, additional methods may be defined in NR Release 16 with regard to UL grant-based PUSCH transmission and configured grant-based PUSCH transmission across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case where repetition transmissions are performed inside a single slot through method 2, if there are multiple bundles of consecutive uplink symbols in the corresponding slot, respective repetition transmissions may be performed with regard to respective uplink symbol bundles. If there is only a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the n^{th} UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. Time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

### [Rate Matching for UCI Multiplexed on PUSCH]

In the following description, rate matching for uplink control information (UCI) in a 5G system will be explained in detail. Before describing rate matching for UCI, a case in which UCI is multiplexed on a PUSCH will be described. When a PUCCH and a PUSCH overlap and a timeline condition for UCI multiplexing is satisfied, the UE may multiplex, on the PUSCH, a HARQ-ACK and/or CSI information included in the PUCCH according to UCI information included in the PUSCH, and may not transmit the PUCCH. For the timeline condition for UCI multiplexing, the 3GPP specification TS 38.213 clause 9.2.5 may be referenced. As an example of the timeline condition for UCI multiplexing, if one of PUCCH transmission or PUSCH transmission is scheduled through DCI, the UE may perform UCI multiplexing when the first symbol SO of the earliest PUCCH or PUSCH among PUCCHs and PUSCHs overlapping on slots satisfies the following condition.
S₀ is not a symbol transmitted before a symbol including a CP and starting after

$${T}_{proc , 1}^{mux}$$

from the last symbol of a corresponding PDSCH. Here,

$${T}_{proc , 1}^{mux}$$

is the maximum value among

$$\{ {T}_{pr oc , 1}^{mux , 1} , … , {T}_{proc , 1}^{mux , i} , … \}$$

for the i-th PDSCH associated with a HARQ-ACK transmitted through a PUCCH in a group of the overlapping PUCCHs and PUSCHs.

$${T}_{proc , 1}^{mux , i}$$

is a processing procedure time for the i-th PDSCH and defined as

$${T}_{proc , 1}^{mux ,} = ( {N}_{1} + {d}_{1 , 1} ) \cdot ( 2048 + 144 ) \cdot κ \cdot {2}^{- μ} \cdot {T}_{c} .$$

Here, d_{1,1} is value determined for the i-th PDSCH by referring to the 3GPP specification TS 38.214 clause 5.3, and N₁ is a PDSCH processing time value according to a PDSCH processing capability. In addition, μ is the smallest subcarrier configuration value among a PDCCH scheduling the i-th PDSCH, the i-th PDSCH, a PUCCH including a HARQ-ACK for the i-th PDSCH, and all the PUSCHs in the group of the overlapping PUCCHs and PUSCHs. T_{c} is 1/(Δfₘₐₓ·N_{f}), Δfₘₐₓ is equal to 480·10³⁰ Hz, Ne is equal to 4096, and k is equal to 64.

This is a part of timeline conditions for UCI multiplexing, and when all conditions are satisfied by referring to the 3GPP specification TS 38.213 clause 9.2.5, the UE may perform UCI multiplexing on a PUSCH.

When a PUCCH and a PUSCH overlap, a timeline condition for UCI multiplexing is satisfied, and the UE determines to multiplex, on the PUSCH, UCI included in the PUCCH, the UE performs UCI rate matching for multiplexing the UCI. UCI multiplexing is performed in the order of a HARQ-ACK and configured grant uplink control information (CG-UCI), CSI part 1, and CSI part 2. The UE performs rate matching in consideration of the UCI multiplexing order. Therefore, the UE calculates coded modulation symbols per layer for a HARQ-ACK and CG-UCI, and by considering the symbols, calculates coded modulation symbols per layer for CSI part 1. Thereafter, the UE calculates coded modulation symbols per layer for CSI part 2 aby considering the respective coded modulation symbols per layer for the HARQ-ACK, CG-UCI, and CSI part 1.

When rate matching is performed according to each UCI type, a method for calculating the number of coded modulation symbols per layer varies according to a repetition type of a PUSCH on which the UCI is multiplexed and whether uplink data (uplink shared channel, hereinafter, UL-SCH) is included. For example, when rate matching for HARQ-ACK is performed, a calculation formula of coded modulation symbols per layer according to a PUSCH on which UCI is multiplexed is as shown in the following equation.

$$Equation 3$$

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

$$Equation 4$$

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \}$$

$$Equation 5$$

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

Equation 3 is a calculation formula of coded modulation symbols per layer for a HARQ-ACK multiplexed on a PUSCH that is not PUSCH repetition type B including a UL-SCH. Equation 4 is a calculation formula of coded modulation symbols per layer for a HARQ-ACK multiplexed on PUSCH repetition type B including a UL-SCH. Equation 5 is a calculation formula of coded modulation symbols per layer for a HARQ-ACK multiplexed on a PUSCH not including a UL-SCH.

In Equation 3, O_{ACK} is the number of HARQ-ACK bits. L_{ACK} is the number of CRC bits for the HARQ-ACK.

$${β}_{offset}^{PUSCH}$$

is a beta offset for the HARQ-ACK and is equal to

$${β}_{offset}^{HARQ - ACK} .$$

C_{UL-SCH} is the number of codeblocks of the UL-SCH for the PUSCH transmission, and Kr is the codeblock size of the r-th codeblock.

$${M}_{sc}^{UCI} ( l )$$

denotes the number of resource elements available for UCI transmission on symbol l, and the number is determined according to whether a DMRS and a PTRS exist on symbol l. If a DMRS is included in symbol l,

$${M}_{sc}^{UCI} ( l ) = 0$$

is satified.

$${M}_{sc}^{UCI} ( l ) = {M}_{sc}^{PUSCH} - {M}_{sc}^{PT - RS} ( l )$$

is met for symbol l not including a DMRS.

$${M}_{sc}^{PUSCH}$$

is the number of subcarriers for a bandwidth in which the PUSCH transmission is scheduled, and

$${M}_{sc}^{PT - RS} ( l )$$

is the number of ubcarriers including s PTRS in symb l

$${M}_{symb , all}^{PUSCH}$$

denotes the number of all the symbols of the PUSCH. α is the higher layer parameter scaling, and indicates the ratio of resources on which UCI is multiplexible among all the resources for the PUSCH transmission. l₀ indicates the index of the first symbol not including DMRSs after the first DMRS.

In Equation 4,

$${M}_{sc , nominal}^{UCI} ( l )$$

indicates the number of resource elements available for UCI transmission of nominal repetition, is equal to 0 for a symbol including a DMRS, and is represented as

$${M}_{sc , nominal}^{UCI} ( l ) = {M}_{sc}^{PUSCH} - {M}_{sc , nominal}^{PT - RS} ( l )$$

for a symbol not including a DMRS, and

$${M}_{sc , nominal}^{PT - RS} ( l )$$

indicates the number of subcarriers including a PTRS in symbol l for the PUSCH for which nominal repetition is assumed.

$${N}_{symb , nominal}^{PUSCH}$$

indicates the number of all the symbols for nominal repetition of the PUSCH.

$${M}_{sc , actual}^{UCI} ( l )$$

indicates the number of resource elements available for UCI transmission of actual repetition, is equal to 0 for a symbol including a DMRS, and is represented as

$${M}_{sc , actual}^{UCI} ( l ) = {M}_{sc}^{PUSCH} - {M}_{sc , actual}^{PT - RS} ( l )$$

for a symbol not including a DMRS, and

$${M}_{sc , actual}^{PT - RS} ( l )$$

indicates the number of subcarriers including a PTRS in symbol l for actual repetition of the PUSCH.

$${N}_{symb , actual}^{PUSCH}$$

indicates the number of all the symbols for actual repetition of the PUSCH. In Equation 5, R is a code rate of the PUSCH, and Qₘ is a modulation order of the PUSCH.

The number of coded modulation symbols per layer for which rate matching of CSI part 1 is performed may also be calculated similarly to a case of HARQ-ACK, but the number of maximally allocatable resources among all the resources is reduced to a value remaining after excluding the number of coded modulation symbols for HARQ-ACK/CG-UCI. A calculation formula of coded modulation symbols per layer of CSI part 1 is as shown in Equation 6, Equation 7, Equation 8, and Equation 9 according to the repetition type of a PUSCH and whether a UL-SCH is included.

$$Equation 6$$

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$$

$$Equation 7$$

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} \}$$

$$Equation 8$$

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$$Equation 9$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′}$$

Equation 6 is a calculation formula of coded modulation symbols per layer for CSI part 1 multiplexed on a PUSCH that is not PUSCH repetition type B including a UL-SCH. Equation 7 is a calculation formula of coded modulation symbols per layer for CSI part 1 multiplexed on PUSCH repetition type B including a UL-SCH. [Equation 8] is a calculation formula of coded modulation symbols per layer for multiplexed CSI part 1 when CSI part 1 and CSI part 2 are multiplexed on a PUSCH not including a UL-SCH. Equation 9 is a calculation formula of coded modulation symbols per layer for multiplexed CSI part 1 when CSI part 2 is not multiplexed on a PUSCH not including a UL-SCH. In Equation 6, O_{CSI-1} and L_{CSI-1} indicate the number of bits of CSI part 1 and the number of CRC bits for CSI part 1, respectively.

$${β}_{offset}^{PUSCH}$$

iS a beta offset for CSI part 1 and is equal to

$${β}_{offset}^{CSI - part 1} \cdot {Q}_{\frac{ACK}{CG} - UCI}^{′}$$

is the number of coded modulation symbols per layer calculated for HARQ-ACK and/or CG-UCI. The other parameters are the same as parameters required for calculating the number of coded modulation symbols per layer for HARQ-ACK described above.

The number of coded modulation symbols per layer for which rate matching of CSI part 2 is performed may also be calculated similarly to a case of CSI part 1, but the number of maximally allocatable resources among all the resources is reduced to a value remaining after excluding the number of coded modulation symbols for HARQ-ACK/CG-UCI and the number of coded modulation symbols for CSI part 2. A calculation formula of coded modulation symbols per layer of CSI part 1 is as shown in Equation 10, Equation 11, and Equation 12 according to the repetition type of a PUSCH and whether a UL-SCH is included.

$$Equation 10$$

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′} \}$$

$$Equation 11$$

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} - {Q}_{CSI - 1}^{′} \}$$

$$Equation 12$$

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$$

Equation 10 is a calculation formula of coded modulation symbols per layer for CSI part 2 multiplexed on a PUSCH that is not PUSCH repetition type B including a UL-SCH. Equation 11 is a calculation formula of coded modulation symbols per layer for CSI part 2 multiplexed on PUSCH repetition type B including a UL-SCH. Equation 12 is a calculation formula of coded modulation symbols per layer for CSI part 2 multiplexed on a PUSCH not including a UL-SCH. In Equation 10, O_{CSI-2} and L_{CSI-2} indicate the number of bits of CSI part 2 and the number of CRC bits for CSI part 2, respectively.

$${β}_{offset}^{PUSCH}$$

iS a vera onset for CSI part 2 and is equal to

$${β}_{offset}^{CSI - part 2} .$$

The other parameters are the same as parameters required for calculating the number of coded modulation symbols per layer for HARQ-ACK and CSI part 1 described above.

The number of coded modulation symbols per layer for which rate matching of CG-UCI is performed may also be calculated similarly to a case of HARQ-ACK. A calculation formula of coded modulation symbols per layer of CG-UCI multiplexed on a PUSCH including a UL-SCH is as shown in Equation 13.

$$Equation 13$$

$${Q}_{CG - UGI}^{′} = min \{ ⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

In Equation 13, O_{CG-UCI} and L_{CG-UCI} indicate the number of bits of CG-UCI and the number of CRC bits for the CG-UCI, respectively.

$${β}_{offset}^{PUSCH}$$

iS a vela ousel for the CG-UCI and is equal to

$${β}_{offset}^{CSI - UCI} .$$

The other parameters are the same as parameters required for calculating the number of coded modulation symbols per layer for HARQ-ACK described above.

When a HARQ-ACK and CG-UCI are multiplexed on a PUSCH including a UL-SCH, the number of coded modulation symbols per layer for which rate matching of the HARQ-ACK and CG-UCI is performed may be calculated as shown on Equation 14.

$$Equation 14$$

$${Q}_{CG - UGI}^{′} = min \{ ⌈ \frac{( {O}_{ACK} + {O}_{CG - UCI} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

In Equation 14,

$${β}_{offset}^{PUSCH}$$

is a beta HARQ-ACK and is equal to

$${β}_{offset}^{HARQ - ACK} ,$$

and the other parameters are the same as parameters required for calculating the number of coded modulation symbols per layer for HARQ-ACK described above.

### [Related to CSI Measurement and Reporting]

Hereinafter, a method of measuring and reporting a channel state in a 5G communication system will be described in detail.

Channel state information (CSI) may include a channel quality indicator (CQI), a precoding matrix index (PMI), a CSI-RS resource indicator (CRI), a synchronization signal (SS)/physical broadcast channel (PBCH) block resource indicator (SSBRI), a layer indicator (LI), a rank indicator (RI), and/or L1-reference signal received power (RSRP). The base station may control time and frequency resources for CSI measurement and reporting by the UE.

For CSI measurement and reporting as described above, at least one of configuration information (CSI-ReportConfig) for N(≥1) CSI reports, configuration information (CSI-ResourceConfig) for M(≥1) RS transmission resources, and the trigger state lists CSI-AperiodicTriggerStateList and CSI-SemiPersistentOnPUSCH-TriggerStateList may be configured for the UE through higher layer signaling.

More specifically, the above configuration information for CSI measurement and reporting may be as described in Tables 25 to 31 below.

TABLE 25
The IE CSI-ReportConfig is used to configure a periodic or semi-persistent
report sent on PUCCH on the cell in which the CSI-ReportConfig is
included, or to configure a semi-persistent or aperiodic report sent
on PUSCH triggered by DCI received on the cell in which the CSI-
ReportConfig is included (in this case, the cell on which the report
is sent is determined by the received DCI). See TS.214, clause 5.2.1.
CSI-ReportConfig information element

```
-- ASN1START
-- TAG-CSI-REPORTCONFIG-START
CSI-ReportConfig ::= SEQUENCE {
  reportConfigId CSI-ReportConfigId,
  carrier  ServCellIndex  OPTIONAL,  --
Need S
  resourcesForChannelMeasurement CSI-ResourceConfigId,
  csi-IM-ResourcesForInterference  CSI-ResourceConfigId
OPTIONAL,  -- Need R
  nzp-CSI-RS-ResourcesForInterference  CSI-ResourceConfigId
OPTIONAL,  -- Need R
  reportConfigType CHOICE {
    periodic SEQUENCE {
      reportSlotConfig CSI-ReportPeriodicityAndOffset,
      pucch-CSI-ResourceList SEQUENCE (SIZE
(1..maxNrofBWPs)) OF PUCCH-CSI-Resource
    },
    semiPersistentOnPUCCH  SEQUENCE {
      reportSlotConfig CSI-ReportPeriodicityAndOffset,
      pucch-CSI-ResourceList SEQUENCE (SIZE
(1..maxNrofBWPs)) OF PUCCH-CSI-Resource
    },
    semiPersistentOnPUSCH  SEQUENCE {
      reportSlotConfig ENUMERATED {sl5, sl10, sl20,
sl40, sl80, sl160, sl320},
      reportSlotOffsetList SEQUENCE (SIZE (1..
maxNrofUL-Allocations)) OF INTEGER(0..32),
      p0alpha  P0-PUSCH-AlphaSetId
    },
    aperiodic  SEQUENCE {
      reportSlotOffsetList SEQUENCE (SIZE (1..maxNrofUL-
Allocations)) OF INTEGER(0..32)
    }
  },
  reportQuantity CHOICE {
    none NULL,
    cri-RI-PMI-CQI NULL,
    cri-RI-i1  NULL,
    cri-RI-i1-CQI  SEQUENCE {
      pdsch-BundleSizeForCSI ENUMERATED {n2, n4}
OPTIONAL -- Need S
}
    },
    cri-RI-CQI NULL,
    cri-RSRP NULL,
    ssb-Index-RSRP NULL,
    cri-RI-LI-PMI-CQI  NULL
  },
  reportFreqConfiguration  SEQUENCE {
    cqi-FormatIndicator  ENUMERATED { widebandCQI,
subbandCQI } OPTIONAL,  -- Need R
    pmi-FormatIndicator  ENUMERATED { widebandPMI,
subbandPMI } OPTIONAL,  -- Need R
    csi-ReportingBand  CHOICE {
      subbands3  BIT STRING(SIZE(3)),
      subbands4  BIT STRING(SIZE(4)),
      subbands5  BIT STRING(SIZE(5)),
      subbands6  BIT STRING(SIZE(6)),
      subbands7  BIT STRING(SIZE(7)),
      subbands8  BIT STRING(SIZE(8)),
      subbands9  BIT STRING(SIZE(9)),
      subbands10 BIT STRING(SIZE(10)),
      subbands11 BIT STRING(SIZE(11)),
      subbands12 BIT STRING(SIZE(12)),
      subbands13 BIT STRING(SIZE(13)),
      subbands14 BIT STRING(SIZE(14)),
      subbands15 BIT STRING(SIZE(15)),
      subbands16 BIT STRING(SIZE(16)),
      subbands17 BIT STRING(SIZE(17)),
      subbands18 BIT STRING(SIZE(18)),
      ...,
      subbands19-v1530 BIT STRING(SIZE(19))
    }  OPTIONAL -- Need S
OPTIONAL,  -- Need R
  timeRestrictionForChannelMeasurements  ENUMERATED
{configured, notConfigured},
  timeRestrictionForInterferenceMeasurements ENUMERATED
{configured, notConfigured},
  codebookConfig CodebookConfig
OPTIONAL,  -- Need R
  dummy  ENUMERATED {n1, n2}
OPTIONAL,  -- Need R
  groupBasedBeamReporting  CHOICE {
    enabled  NULL,
    disabled SEQUENCE {
      nrofReportedRS ENUMERATED {n1, n2, n3, n4}
OPTIONAL -- Need S
    }
  },
  cqi-Table  ENUMERATED {table1, table2, table3,
spare1}  OPTIONAL,  -- Need R
  subbandSize  ENUMERATED {value1, value2},
  non-PMI-PortIndication SEQUENCE (SIZE (1..maxNrofNZP-
CSI-RS-ResourcesPerConfig)) OF PortIndexFor8Ranks OPTIONAL,  --
Need R
  ...,
  [[
  semiPersistentOnPUSCH-v1530  SEQUENCE {
    reportSlotConfig-v1530 ENUMERATED {sl4, sl8, sl16}
  }
OPTIONAL -- Need R
  ]]
}
CSI-ReportPeriodicityAndOffset ::= CHOICE {
  slots4 INTEGER(0..3),
  slots5 INTEGER(0..4),
  slots8 INTEGER(0..7),
  slots10  INTEGER(0..9),
  slots16  INTEGER(0..15),
  slots20  INTEGER(0..19),
  slots40  INTEGER(0..39),
  slots80  INTEGER(0..79),
  slots160 INTEGER(0..159),
  slots320 INTEGER(0..319),
}
PUCCH-CSI-Resource ::= SEQUENCE {
  uplinkBandwidthPartID BWP-Id,
  pucch-Resource PUCCH-ResourceId
}
PortIndexFor8Ranks ::= CHOICE {
  portIndex8 SEQUENCE{
    rank1-8  PortIndex8
OPTIONAL,  -- Need R
    rank2-8  SEQUENCE(SIZE(2)) OF PortIndex8
OPTIONAL,  -- Need R
    rank3-8  SEQUENCE(SIZE(3)) OF PortIndex8
OPTIONAL,  -- Need R
    rank4-8  SEQUENCE(SIZE(4)) OF PortIndex8
OPTIONAL,  -- Need R
    rank5-8  SEQUENCE(SIZE(5)) OF PortIndex8
OPTIONAL,  -- Need R
    rank6-8  SEQUENCE(SIZE(6)) OF PortIndex8
OPTIONAL,  -- Need R
    rank7-8  SEQUENCE(SIZE(7)) OF PortIndex8
OPTIONAL,  -- Need R
    rank8-8  SEQUENCE(SIZE(8)) OF PortIndex8
OPTIONAL -- Need R
  },
  portIndex4 SEQUENCE{
    rank1-4  PortIndex4
OPTIONAL,  -- Need R
    rank2-4  SEQUENCE(SIZE(2)) OF PortIndex4
OPTIONAL,  -- Need R
    rank3-4  SEQUENCE(SIZE(3)) OF PortIndex4
OPTIONAL,  -- Need R
    rank4-4  SEQUENCE(SIZE(4)) OF PortIndex4
OPTIONAL -- Need R
  },
  portIndex2 SEQUENCE{
    rank1-2  PortIndex2
OPTIONAL,  -- Need R
    rank2-2  SEQUENCE(SIZE(2)) OF PortIndex2
OPTIONAL -- Need R
  },
  portIndex1 NULL
}
PortIndex8::=  INTEGER (0..7)
PortIndex4::=  INTEGER (0..3)
PortIndex2::=  INTEGER (0..1)
-- TAG-CSI-REPORTCONFIG-STOP
-- ASN1STOP
```

TABLE 25-1
CSI-ReportConfig field descriptions
carrier
Indicates in which serving cell the CSI-ResourceConfig indicated below are to be
found. If the field is absent, the resources are on the same serving cell as this report
configuration.
codebookConfig
Codebook configuration for Type-1 or Type-II including codebook subset
restriction.
cqi-FormatIndicator
Indicates whether the UE shall report a single (wideband) or multiple (subband)
CQI. (see TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the
field “carrier” above. The CSI-ResourceConfig indicated here contains only CSI-
IM resources. The bwp-Id in that CSI-ResourceConfig is the same value as the bwp-
Id in the CSI-ResourceConfig indicated by resourcesForChannelMeasurement.
csi-ReportingBand
Indicates a contiguous or non-contiguous subset of subbands in the bandwidth part
which CSI shall be reported for. Each bit in the bit-string represents one subband.
The right-most bit in the bit string represents the lowest subband in the BWP. The
choice determines the number of subbands (subbands3 for 3 subbands, subbands4
for 4 subbands, and so on) (see TS 38.214 [19], clause 5.2.1.4). This field is absent
if there are less than 24 PRBs (no sub band) and present otherwise, the number of
sub bands can be from 3 (24 PRBs, sub band size 8) to 18 (72 PRBs, sub band size
4).
dummy
This field is not used in the specification. If received it shall be ignored by the UE.
groupBasedBeamReporting
Turning on/off group beam based reporting (see TS 38.214 [19], clause 5.2.1.4)
non-PMI-PortIndication
Port indication for RI/CQI calculation. For each CSI-RS resource in the linked
ResourceConfig for channel measurement, a port indication for each rank R,
indicating which R ports to use. Applicable only for non-PMI feedback (see TS
38.214 [19], clause 5.2.1.4.2).
The first entry in non-PMI-PortIndication corresponds to the NZP-CSI-RS-
Resource indicated by the first entry in nzp-CSI-RS-Resources in the NZP-CSI-RS-
ResourceSet indicated in the first entry of nzp-CSI-RS-ResourceSetList of the CSI-
ResourceConfig whose CSI-ResourceConfigId is indicated in a CSI-MeasId
together with the above CSI-ReportConfigId; the second entry in non-PMI-
PortIndication corresponds to the NZP-CSI-RS-Resource indicated by the second
entry in nzp-CSI-RS-Resources in the NZP-CSI-RS-ResourceSet indicated in the
first entry of nzp-CSI-RS-ResourceSetList of the same CSI-ResourceConfig, and so
on until the NZP-CSI-RS-Resource indicated by the last entry in nzp-CSI-RS-
Resources in the in the NZP-CSI-RS-ResourceSet indicated in the first entry of nzp-
CSI-RS-ResourceSetList of the same CSI-ResourceConfig. Then the next entry
corresponds to the NZP-CSI-RS-Resource indicated by the first entry in nzp-CSI-
RS-Resources in the NZP-CSI-RS-ResourceSet indicated in the second entry of nzp-
CSI-RS-ResourceSetList of the same CSI-ResourceConfig and so on.
nrofReportedRS
The number (N) of measured RS resources to be reported per report setting in a non-
group-based report. N <= N_max, where N_max is either 2 or 4 depending on UE
capability.
(see TS 38.214 [19], clause 5.2.1.4) When the field is absent the UE applies the
value 1
nzp-CSI-RS-ResourcesForInterference
NZP CSI RS resources for interference measurement. csi-ResourceConfigId of a
CSI-ResourceConfig included in the configuration of the serving cell indicated with
the field “carrier” above. The CSI-ResourceConfig indicated here contains only
NZP-CSI-RS resources. The bwp-Id in that CSI-ResourceConfig is the same value
as the bwp-Id in the CSI-ResourceConfig indicated by resourcesForChannelMeasurement.
p0alpha
Index of the p0-alpha set determining the power control for this CSI report
transmission (see TS 38.214 [19], clause 6.2.1.2).
pdsch-BundleSizeForCSI
PRB bundling size to assume for CQI calculation when reportQuantity is
CRI/RI/i1/CQI. If the field is absent, the UE assumes that no PRB bundling is
applied (see TS 38.214 [19], clause 5.2.1.4.2).
pmi-FormatIndicator
Indicates whether the UE shall report a single (wideband) or multiple (subband)
PMI. (see TS 38.214 [19], clause 5.2.1.4).
pucch-CSI-ResourceList
Indicates which PUCCH resource to use for reporting on PUCCH.
reportConfigType
Time domain behavior of reporting configuration
reportFreqConfiguration
Reporting configuration in the frequency domain. (see TS 38.214 [19], clause
5.2.1.4).
reportQuantity
The CSI related quantities to report. Corresponds to L1 parameter ‘ReportQuantity’
(see TS 38.214 [19], clause 5.2.1).
reportSlotConfig
Periodicity and slot offset (see TS 38.214 [19], clause 5.2.1.4).
reportSlotConfig-v1530
Extended value range for reportSlotConfig for semi-persistent CSI on PUSCH. If
the field is present, the UE shall ignore the value provided in the legacy field
(semiPersistentOnPUSCH.reportSlotConfig).
reportSlotOffsetList
Timing offset Y for semi persistent reporting using PUSCH. This field lists the
allowed offset values. This list must have the same number of entries as the pusch-
TimeDomainAllocationList in PUSCH-Config. A particular value is indicated in
DCI. The network indicates in the DCI field of the UL grant, which of the
configured report slot offsets the UE shall apply. The DCI value 0 corresponds to
the first report slot offset in this list, the DCI value 1 corresponds to the second report
slot offset in this list, and so on. The first report is transmitted in slot n+Y, second
report in n+Y+P, where P is the configured periodicity.
Timing offset Y for aperiodic reporting using PUSCH. This field lists the allowed
offset values. This list must have the same number of entries as the pusch-
TimeDomainAllocationList in PUSCH-Config. A particular value is indicated in
DCI. The network indicates in the DCI field of the UL grant, which of the
configured report slot offsets the UE shall apply. The DCI value 0 corresponds to
the first report slot offset in this list, the DCI value 1 corresponds to the second report
slot offset in this list, and so on (see TS 38.214 [19], clause 5.2.3).
resourcesForChannelMeasurement
Resources for channel measurement. csi-ResourceConfigId of a CSI-
ResourceConfig included in the configuration of the serving cell indicated with the
field “carrier” above. The CSI-ResourceConfig indicated here contains only NZP-
CSI-RS resources and/or SSB resources. This CSI-ReportConfig is associated with
the DL BWP indicated by bwp-Id in that CSI-ResourceConfig.
subbandSize
Indicates one out of two possible BWP-dependent values for the subband size as
indicated in TS 38.214 [19], table 5.2.1.4-2. If csi-ReportingBand is absent, the UE
shall ignore this field.
timeRestrictionForChannelMeasurements
Time domain measurement restriction for the channel (signal) measurements (see
TS 38.214 [19], clause 5.2.1.1)
timeRestrictionForInterferenceMeasurements
Time domain measurement restriction for interference measurements (see TS
38.214 [19], clause 5.2.1.1)

TABLE 26
The IE CSI-ResourceConfig defines a group of one or more NZP-CSI-RS-ResourceSet,
CSI-IM-ResourceSet and/or CSI-SSB-ResourceSet.
CSI-ResourceConfig information element

```
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE (1..maxNrofNZP-CSI-
RS-ResourceSetsPerConfig)) OF NZP-CSI-RS-ResourceSetId
OPTIONAL, -- Need R
      csi-SSB-ResourceSetList  SEQUENCE (SIZE (1..maxNrofCSI-SSB-
ResourceSetsPerConfig)) OF CSI-SSB-ResourceSetId
OPTIONAL -- Need R
    },
    csi-IM-ResourceSetList SEQUENCE (SIZE (1..maxNrofCSI-IM-
ResourceSetsPerConfig)) OF CSI-IM-ResourceSetId
  },
  bwp-Id BWP-Id,
  resourceType ENUMERATED { aperiodic, semiPersistent, periodic },
  ...
}
-- TAG-CSI-RESOURCECONFIG-STOP
-- ASN1STOP
```

TABLE 26-1
CSI-ResourceConfig field descriptions
bwp-Id
The DL BWP which the CSI-RS associated with this CSI-ResourceConfig are
located in (see TS 38.214 [19], clause 5.2.1.2
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if
ResourceConfigType is ‘aperiodic’ and 1 otherwise (see TS 38.214 [19], clause
5.2.1.2)
csi-SSB-ResourceSetList
List of SSB resources used for beam measurement and reporting in a resource set
(see TS 38.214 [19], section FFS_Section)
resourceType
Time domain behavior of resource configuration (see TS 38.214 [19], clause
5.2.1.2). It does not apply to resources provided in the csi-SSB-ResourceSetList.

TABLE 27
The IE NZP-CSI-RS-ResourceSet is a set of Non-Zero-Power (NZP)
CSI-RS resources (their IDs) and set-specific parameters.
NZP-CSI-RS-ResourceSet information element

```
-- ASN1START
-- TAG-NZP-CSI-RESOURCESET-START
NZP-CSI-RS-ResourceSet ::= SEQUENCE {
  nzp-CSI-ResourceSetId  NZP-CSI-RS-ResourceSetId,
  nzp-CSI-RS-Resources SEQUENCE (SIZE (1..maxNrofNZP-
CSI-RS-ResourcesPerSet)) OF NZP-CSI-RS-ResourceId,
  repetition ENUMERATED { on, off }
OPTIONAL,  -- Need S
  aperiodicTriggeringOffset  INTEGER(0..6)
OPTIONAL,  -- Need S
  trs-Info ENUMERATED {true}
OPTIONAL,  -- Need R
  ...
}
-- TAG-NZP-CSI-RESOURCESET-STOP
-- ASN1STOP
```

TABLE 27-1
NZP-CSI-RS-ResourceSet field descriptions
aperiodicTriggeringOffset
Offset X between the slot containing the DCI that triggers a set of aperiodic NZP
CSI-RS resources and the slot in which the CSI-RS resource set is transmitted. The
value 0 corresponds to 0 slots, value 1 corresponds to 1 slot, value 2 corresponds to
2 slots, value 3 corresponds to 3 slots, value 4 corresponds to 4 slots, value 5
corresponds to 16 slots, value 6 corresponds to 24 slots. When the field is absent
the UE applies the value 0.
nzp-CSI-RS-Resources
NZP-CSI-RS-Resources associated with this NZP-CSI-RS resource set (see TS
38.214 [19], clause 5.2). For CSI, there are at most 8 NZP CSI RS resources per
resource set
repetition
Indicates whether repetition is on/off. If the field is set to ‘OFF’ or if the field is
absent, the UE may not assume that the NZP-CSI-RS resources within the resource
set are transmitted with the same downlink spatial domain transmission filter and
with same NrofPorts in every symbol (see TS 38.214 [19], clauses 5.2.2.3.1 and
5.1.6.1.2). Can only be configured for CSI-RS resource sets which are associated
with CSI-ReportConfig with report of L1 RSRP or “no report”
trs-Info
Indicates that the antenna port for all NZP-CSI-RS resources in the CSI-RS resource
set is same. If the field is absent or released the UE applies the value “false” (see
TS 38.214 [19], clause 5.2.2.3.1).

TABLE 28
The IE CSI-SSB-ResourceSet is used to configure one SS/PBCH block
resource set which refers to SS/PBCH as indicated in
ServingCellConfigCommon.
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}
-- TAG-CSI-SSB-RESOURCESET-STOP
-- ASN1STOP

TABLE 29
The IE CSI-IM-ResourceSet is used to configure a set of one or more
CSI Interference Management (IM) resources (their IDs) and set-specific
parameters.
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

ResourcesPerSet)) OF CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet (see TS 38.214 [19],
clause 5.2)

TABLE 30
The CSI-AperiodicTriggerStateList IE is used to configure the UE with a list
of aperiodic trigger states. Each codepoint of the DCI field “CSI request”
is associated with one trigger state. Upon reception of the value associated with a
trigger state, the UE will perform measurement of CSI-RS (reference signals) and
aperiodic reporting on L1 according to all entries in the
associatedReportConfigInfoList for that trigger state.
CSI-AperiodicTriggerStateList information element

```
-- ASN1START
-- TAG-CSI-APERIODICTRIGGERSTATELIST-START
CSI-AperiodicTriggerStateList ::=  SEQUENCE (SIZE (1..maxNrOfCSI-
AperiodicTriggers)) OF CSI-AperiodicTriggerState
CSI-AperiodicTriggerState ::=  SEQUENCE {
  associatedReportConfigInfoList SEQUENCE
(SIZE(1..maxNrofReportConfigPerAperiodicTrigger)) OF CSI-
AssociatedReportConfigInfo,
  ...
}
CSI-AssociatedReportConfigInfo ::= SEQUENCE {
  reportConfigId CSI-ReportConfigId,
  resourcesForChannel  CHOICE {
    nzp-CSI-RS SEQUENCE {
      resourceSet  INTEGER (1..maxNrofNZP-CSI-RS-
ResourceSetsPerConfig),
      qcl-info SEQUENCE (SIZE(1..maxNrofAP-CSI-RS-
ResourcesPerSet)) OF TCI-StateId OPTIONAL -- Cond Aperiodic
    },
    csi-SSB-ResourceSet  INTEGER (1..maxNrofCSI-SSB-
ResourceSetsPerConfig)
  },
  csi-IM-ResourcesForInterference  INTEGER(1..maxNrofCSI-IM-
ResourceSetsPerConfig)  OPTIONAL, -- Cond CSI-IM-ForInterference
  nzp-CSI-RS-ResourcesForInterference INTEGER (1..maxNrofNZP-CSI-RS-
ResourceSetsPerConfig) OPTIONAL, -- Cond NZP-CSI-RS-ForInterference
  ...
}
-- TAG-CSI-APERIODICTRIGGERSTATELIST-STOP
-- ASN1STOP
```

TABLE 30-1
CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId
above (1 corresponds to the first entry, 2 to the second entry, and so on). The
indicated CSI-IM-ResourceSet should have exactly the same number of resources
like the NZP-CSI-RS-ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by
reportConfigId above (1 corresponds to the first entry, 2 to the second entry, and so
on).
nzp-CSI-RS-ResourcesForInterference
NZP-CSI-RS-ResourceSet for interference measurement. Entry number in nzp-
CSI-RS-ResourceSetList in the CSI-ResourceConfig indicated by nzp-CSI-RS-
ResourcesForInterference in the CSI-ReportConfig indicated by reportConfigId
above (1 corresponds to the first entry, 2 to the second entry, and so on).
qcl-info
List of references to TCI-States for providing the QCL source and QCL type for
each NZP-CSI-RS-Resource listed in nzp-CSI-RS-Resources of the NZP-CSI-RS-
ResourceSet indicated by nzp-CSI-RS-ResourcesforChannel. Each TCI-StateId
refers to the TCI-State which has this value for tci-StateId and is defined in tci-
StatesToAddModList in the PDSCH-Config included in the BWP-Downlink
corresponding to the serving cell and to the DL BWP to which the
resourcesForChannelMeasurement (in the CSI-ReportConfig indicated by
reportConfigId above) belong to. First entry in qcl-info-forChannel corresponds to
first entry in nzp-CSI-RS-Resources of that NZP-CSI-RS-ResourceSet, second entry
in qcl-info-forChannel corresponds to second entry in nzp-CSI-RS-Resources, and
so on (see TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-
RS-ResourceSetList in the CSI-ResourceConfig indicated by
resourcesForChannelMeasurement in the CSI-ReportConfig indicated by
reportConfigId above (1 corresponds to the first entry, 2 to the second entry, and so
on).

| Conditional Presence | Explanation |
|---|---|
| Aperiodic | The field is mandatory present if the NZP-CSI-RS- |
| | Resources in the associated resourceSet have the |
| | resourceType aperiodic. The field is absent otherwise. |
| CSI-IM-ForInterference | This field is optional need M if the CSI-ReportConfig |
| | identified by reportConfigId is configured with csi- |
| | IM-ResourcesForInterference; otherwise it is absent. |
| NZP-CSI-RS- | This field is optional need M if the CSI-ReportConfig |
| ForInterference | identified by reportConfigId is configured with nzp- |
| | CSI-RS-ResourcesForInterference; otherwise it is |
| | absent. |

TABLE 31
The CSI-SemiPersistentOnPUSCH-TriggerStateList IE is used to
configure the UE with list of trigger states for semi-persistent
reporting of channel state information on L1. See also TS 38.214
[19], clause 5.2.
CSI-SemiPersistentOnPUSCH-TriggerStateList information element

-- ASN1START
-- TAG-CSI-SEMIPERSISTENTONPUSCHTRIGGERSTATELIST-
START
CSI-SemiPersistentOnPUSCH-TriggerStateList ::= SEQUENCE(SIZE
(1..maxNrOfSemiPersistentPUSCH-Triggers)) OF CSI-
SemiPersistentOnPUSCH-TriggerState
CSI-SemiPersistentOnPUSCH-TriggerState ::= SEQUENCE {
associatedReportConfigInfo CSI-ReportConfigId,
...
}
-- TAG-CSI-SEMIPERSISTENTONPUSCHTRIGGERSTATELIST-STOP
-- ASN1STOP

Each reporting configuration CSI-ReportConfig may be associated with one downlink (DL) bandwidth part identified by the bandwidth part identifier bwp-Id that is a higher layer parameter given by a CSI resource configuration CSI-ResourceConfig associated with the corresponding reporting configuration. Time domain reporting for each reporting configuration CSI-ReportConfig supports an “aperiodic,” “semi-persistent,” or “periodic” scheme, and the scheme may be configured for the UE by the base station through the higher layer parameter reportConfigType. A semi-persistent CSI reporting method supports semi-persistent reporting on a PUCCH configured by semi-PersistentOnPUCCH and semi-persistent reporting on a PUSCH configured by semi-PersistentOnPUSCH. In a case of periodic or semi-persistent CSI reporting, PUCCH or PUSCH resources on which CSI is to be transmitted may be configured for the UE by the base station through higher layer signaling. The period and slot offset according to which CSI is to be transmitted may be given in the numerology of an uplink (UL) bandwidth part in which a CSI report is configured to be transmitted. In aperiodic CSI reporting, PUSCH resources on which CSI is to be transmitted may be scheduled for the UE by the base station through L1 signaling (e.g., DCI format 0_1).

With respect to a CSI resource configuration CSI-ResourceConfig described above, each CSI resource configuration CSI-ReportConfig may include S (≥1) CSI resource sets (given by the higher layer parameter csi-RS-ResourceSetList). A CSI resource set list may be configured by a non-zero power (NZP) CSI-RS resource set and an SS/PBCH block set, or may be configured by a CSI-interference measurement (CSI-IM) resource set. Each CSI resource configuration may be positioned in a downlink (DL) bandwidth part identified by the higher layer parameter bwp-id, and may be connected to a CSI reporting configuration in the same downlink bandwidth part. A time domain operation of CSI-RS resources in a CSI resource configuration may be configured to be one of “aperiodic,” “periodic,” or “semi-persistent” by the higher layer parameter resourceType. With respect to a periodic or semi-persistent CSI resource configuration, the number of CSI-RS resource sets may be limited to S=1, and a configured period and slot offset may be given in the numerology of a downlink bandwidth part identified by bwp-id. One or more CSI resource configurations for channel or interference measurement may be configured for the UE by the base station through higher layer signaling, and for example, the CSI resource configuration may include at least one of the following resources.
A CSI-IM resource for interference measurement
An NZP CSI-RS resource for interference measurement
An NZP CSI-RS resource for channel measurement

With respect to CSI-RS resource sets associated with a resource configuration having the higher layer parameter resourceType, configured to be “aperiodic,” “periodic,” or “semi-persistent,” a resource configuration for channel or interference measurement on one or multiple component cells (CCs) and a trigger state for a CSI report configuration having reportType configured to be “aperiodic” may be configured by the higher layer parameter CSI-AperiodicTriggerStateList.

Aperiodic CSI reporting of the UE may use a PUSCH, periodic CSI reporting may use a PUCCH, and semi-persistent CSI reporting may be performed using a PUSCH when the reporting is triggered or activated by DCI, and may be performed using a PUCCH after being activated by a MAC control element (MAC CE).

A CSI resource configuration may be also configured to be aperiodic, periodic, or semi-persistent. A combination of a CSI reporting configuration and a CSI resource configuration may be based on Table 32 below.

TABLE 32
Triggering/Activation of CSI Reporting for the possible CSI-RS
Configurations

| CSI-RS | Periodic CSI | Semi-Persistent | Aperiodic CSI |
|---|---|---|---|
| Configuration | Reporting | CSI Reporting | Reporting |
| Periodic CSI- | No dynamic | For reporting on | Triggered by DCI; |
| RS | triggering/activation | PUCCH, the UE | additionally, |
| | | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives triggering | |
| | | on DCI | |
| Semi- | Not Supported | For reporting on | Triggered by DCI; |
| Persistent CSI- | | PUCCH, the UE | additionally, |
| RS | | receives an | activation command |
| | | activation | [10, TS 38.321] |
| | | command [10, TS | possible as defined |
| | | 38.321]; for | in Subclause |
| | | reporting on | 5.2.1.5.1. |
| | | PUSCH, the UE | |
| | | receives triggering | |
| | | on DCI | |
| Aperiodic | Not Supported | Not Supported | Triggered by DCI; |
| CSI-RS | | | additionally, |
| | | | activation command |
| | | | [10, TS 38.321] |
| | | | possible as defined |
| | | | in Subclause |
| | | | 5.2.1.5.1. |

Aperiodic CSI reporting may be triggered by a “CSI request” field in DCI format 0_1 as an example corresponding to scheduling DCI of a PUSCH. The UE may obtain DCI format 0_1 by monitoring a PDCCH and obtain resource allocation information on a PUSCH and a CSI request field from DCI format 0_1. The CSI request field may be configured to have NTS (−0, 1, 2, 3, 4, 5, or 6) bits, and the NTS may be determined by the higher layer parameter reportTriggerSize. One trigger state among one or multiple aperiodic CSI reporting trigger states which may be configured by the higher layer parameter CSI-AperiodicTriggerStateList, may be triggered by the CSI request field.
If all the bits of the CSI request field are 0, this may imply that CSI reporting is not requested.
If the number (M) of the configured CSI trigger states in CSI-AperiodicTriggerStateList is greater than 2N\hat{ }TS-1, the M CSI trigger states may be mapped to (2N\hat{ }TS-1) number of CSI trigger states according to a pre-defined mapping relation, and one trigger state among the (2N\hat{ }TS-1) number of trigger states may be indicated by the CSI request field.
If the number (M) of the configured CSI trigger states in CSI-Aperiodic TriggerStateList is smaller than or equal to 2N\hat{ }TS-1, one of the M CSI trigger states may be indicated by the CSI request field.

Table 33 below shows an example of a relation between a CSI request indicator and a CSI trigger state indicatable thereby.

TABLE 33

| CSI request | CSI trigger | CSI- | CSI- |
|---|---|---|---|
| field | state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may measure a CSI resource in a CSI trigger state triggered by a CSI request field, and then generate CSI (including at least one of CQI, PMI, CRI, SSBRI, LI, RI, L1-RSRP, or L1-SINR) through the measurement. The UE may transmit the generated CSI by using a PUSCH scheduled by DCI format 0_1. If a 1-bit uplink shared channel indicator (UL-SCH indicator) in DCI format 0_1 indicates “1,” the UE may multiplex the generated CSI and uplink data from a UL-SCH on a PUSCH resource scheduled by DCI format 0_1, and transmit the multiplexed data and CSI. If the UL-SCH indicator in DCI format 0_1 indicates “0,” the UE may transmit only the CSI on a PUSCH resource scheduled by DCI format 0_1 without uplink data.

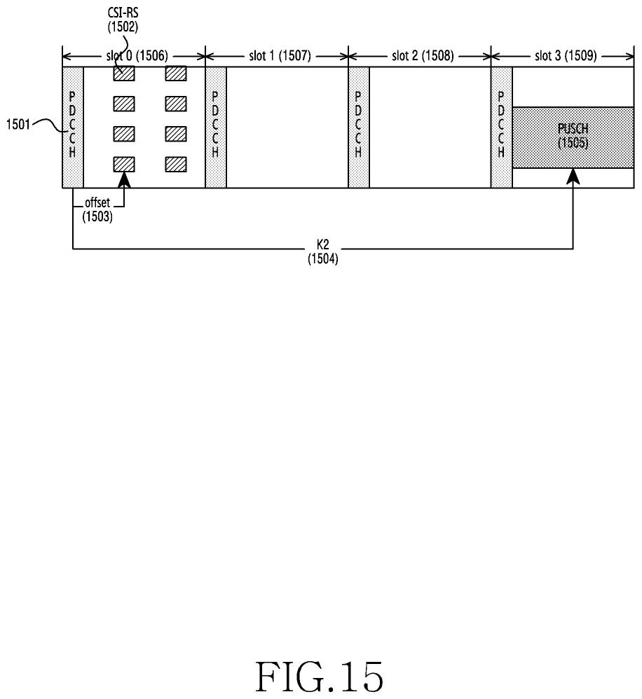

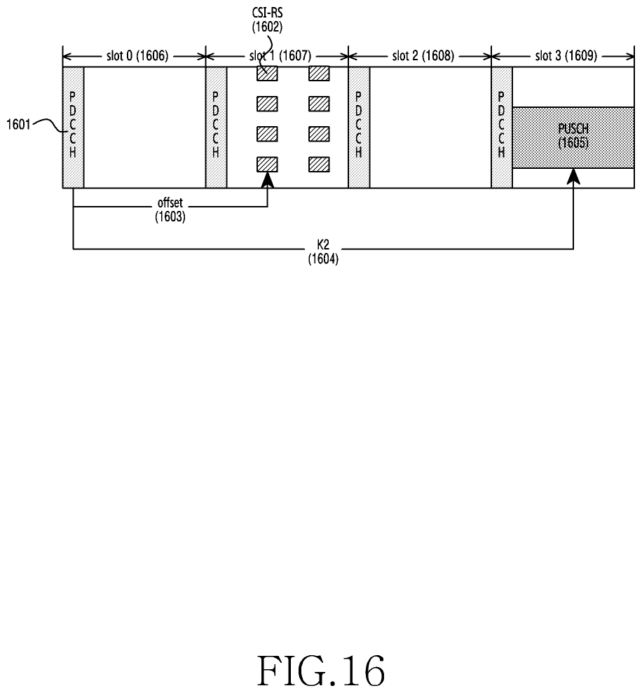

FIG. 15 and FIG. 16 are diagrams illustrating examples of aperiodic channel state reporting according to an embodiment of the disclosure.

Referring to FIG. 15, a UE may monitor a PDCCH 1500 to obtain DCI format 0_1 and obtain scheduling information for a PUSCH 1508 and a CSI request field from the DCI format 0_1. The CSI request field provides resource information on a CSI-RS 1502 to be measured by the UE. The UE may identify a time point to measure a resource of the CSI-RS 1502, based on a time point at which DCI format 0_1 is received and a CSI resource set configuration (e.g., aperiodicTriggeringOffset in NZP-CSI-RS-ResourceSet).

More specifically, the UE may obtain an offset value X 1504 through aperiodicTriggeringOffset that is a parameter in an NZP-CSI-RS resource set given by a higher layer signaling from a base station. The offset value X 804 may indicate the offset between a slot in which DCI triggering an aperiodic CSI report has been received and a slot in which the CSI-RS resource is transmitted. For example, a value of aperiodicTriggeringOffset and the offset value X 1504 may have a mapping relation therebetween as shown in Table 34 below.

TABLE 34

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

FIG. 15 shows an example in which the offset value 1504 is configured to be 0 (X=0). In this case, the UE may receive the CSI-RS 1502 in slot 0 1510 in which DCI format 0_1 triggering an aperiodic CSI report has been received.

The UE may obtain scheduling information (the resource allocation fields in DCI format 0_1 described above) for the PUSCH 1508 for the CSI report from DCI format 0_1. For example, the UE may obtain information on a slot in which the PUSCH 1508 is to be transmitted, from a time domain resource allocation field in DCI format 0_1. In the example in FIG. 15, a value of K2 1506 corresponding to a PDCCH-to-PUSCH slot offset is 3, and accordingly, the PUSCH 1508 including CSI related to the CSI-RS 1502 may be transmitted in slot 3 1512 spaced 3 slots apart from slot 0 1510 that is the time point at which the PDCCH 1500 is received.

Referring to FIG. 16, the UE may monitor a PDCCH 1600 to obtain DCI format 0_1 and obtain scheduling information for a PUSCH 1608 and a CSI request field from the DCI format 0_1. The CSI request field provides resource information on a CSI-RS 1602 to be measured by the UE. FIG. 16 shows an example in which an offset value 1604 for the CSI-RS is configured to be 1 (X=1). In this case, the UE may receive the CSI-RS 1602 in slot 1 1612 that is a time point spaced 1 slot apart from slot 0 1610 in which DCI format 0_1 triggering an aperiodic CSI report has been received. In the illustrated example, a value of K2 1606 corresponding to a PDCCH-to-PUSCH slot offset is given to the UE as 3, and accordingly, the PUSCH 1608 including CSI related to the CSI-RS 1602 may be transmitted in slot 3 1614 spaced 3 slots apart from slot 0 1610 that is the time point at which the PDCCH 1600 is received.

### [CSI: Related to L1-RSRP/L1-SINR Reporting]

In the following description, L1-RSRP reporting in a 5G system is described in detail. A CSI-RS and an SSB may be configured for the UE for L1-RSRP calculation. In a case of CSI-RSs, a maximum of 16 CSI-RS sets and a maximum of 64 CSI-RSs per set may be configured, and the total sum of CSI-RSs does not exceed 128. If nrofReportedRS configured by the higher layer is 1, L1-RSRP is defined as a 7-bit value in [−140,−44] dBm with 1 dB resolution. If nrofReportedRS is greater than 1, groupBasedBeamReporting is configured to be “enabled,” or groupBasedBeamReporting-r17 is configured to be “enabled,” the UE may report a differential L1-RSRP that is a difference from the maximum L1-RSRP. The differential L1-RSRP is defined as a 4-bit value with 2 dB resolution. If timeRestrictionForChannelMeasurements is configured to be “notConfigured” by the higher layer, the UE may calculate and report L1-RSRP, based on an NZP CSI-RS and an SSB before a CSI reference resource, and if same is configured to be “Configured,” the UE may calculate and report the L1-RSRP of the most recent NZP CSI-RS or SSB before the CSI reference resource.

Referring to Table 35, the bitwidth of a CRI, SSBRI, RSRP, differential RSRP, and CapabilityIndex may be calculated and reported.

$${K}_{s}^{CSI - RS}$$

is the number of CSI-RS resource in a corresponding resource set, and

$${K}_{s}^{SSB}$$

is the number of SSBs configured in a corresponding CSI resource set when “ssb-Index-RSRP” is reported.

TABLE 35

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| RSRP | 7 |
| Differential | 4 |
| RSRP | |
| CapabilityIndex | 2 |

Referring to Table 36, a mapping order of a CSI field for reporting CRI/RSRP, SSBRI/RSRP, CRI/RSRP/CapabilityIndex, or SSBRI/RSRP/CapabilityIndex may be calculated. Each CSI field refers to the bitwidth of Table 35.

TABLE 36

| CSI report | |
|---|---|
| number | CSI fields |
| CSI report | CRI or SSBRI #1, if reported |
| #n | CRI or SSBRI #2, if reported |
| | CRI or SSBRI #3, if reported |
| | CRI or SSBRI #4, if reported |
| | RSRP #1, if reported |
| | Differential RSRP #2, if reported |
| | Differential RSRP #3, if reported |
| | Differential RSRP #4, if reported |
| | Capability Index #1, if reported |
| | Capability Index #2, if reported |
| | Capability Index #3, if reported |
| | Capability Index #4, if reported |

CRI k (k>=0) is the (k+1)th entry configured in associated nzp-CSI-RS-Resources of corresponding NZP-CSI-RS-ResourceSet for channel measurement. SSBRI k (k≥0) is the (k+1)th entry configured in associated csi-SSB-ResourceList of corresponding CSI-SSB-ResourceSet for channel measurement.

In the following description, L1-SINR reporting in a 5G system is described in detail. For L1-SINR calculation, an NZP CSI-RS and an SSB may be configured for channel measurement, and an NZP CSI-RS or CSI-IM may be configured for interference measurement. In a case of CSI-RSs, a maximum of 16 CSI-RS sets and a maximum of 64 CSI-RSs per set may be configured, and the total sum of CSI-RSs does not exceed 128.

If nrofReportedRS configured by the higher layer is 1, L1-SINR is defined as a 7-bit value in [−23,40] dBm with 0.5 dB resolution. If nrofReportedRS is greater than 1 or groupBasedBeamReporting is configured to be “enabled,” the UE may report a differential L1-SINR that is a difference from the maximum L1-SINR. The differential L1-RSRP is defined as a 4-bit value with 1 dB resolution.

If timeRestrictionForChannelMeasurements is configured to be “notConfigured” by the higher layer, the UE may calculate and report L1-SINR, based on an NZP CSI-RS or SSB before a CSI reference resource, and if same is configured to be “Configured,” the UE may calculate and report the L1-SINR of the most recent NZP CSI-RS or SSB before the CSI reference resource.

If timeRestrictionForInterferenceMeasurements is configured to be “notConfigured” by the higher layer, the UE may calculate and report L1-SINR, based on an NZP CSI-RS or CSI-IM before a CSI reference resource, and if same is configured to be “Configured,” the UE may calculate and report the L1-SINR of the most recent NZP CSI-RS or CSI-IM before the CSI reference resource.

Referring to Table 37, the bitwidth of a CRI, SSBRI, SINR, differential SINR, and CapabilityIndex may be calculated and reported.

$${K}_{s}^{CSI - RS}$$

is the number o CSI-RS resource in a corresponding resource set, and

$${K}_{s}^{SSB}$$

is the number of SSBs configured in a corresponding CSI resource set when “ssb-Index-RSRP” is reported.

TABLE 37

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| SINR | 7 |
| Differential | 4 |
| SINR | |
| Capability Index | 2 |

Referring to Table 38, a mapping order of a CSI field for reporting CRI/SINR, SSBRI/SINR, CRI/SINR/CapabilityIndex, or SSBRI/SINR/CapabilityIndex may be calculated. Each CSI field refers to the bitwidth of Table 35.

TABLE 38

| CSI report | |
|---|---|
| number | CSI fields |
| CSI report | CRI or SSBRI #1 as in Table 6.3.1.1.2-6A, if reported |
| #n | CRI or SSBRI #2 as in Table 6.3.1.1.2-6A, if reported |
| | CRI or SSBRI #3 as in Table 6.3.1.1.2-6A, if reported |
| | CRI or SSBRI #4 as in Table 6.3.1.1.2-6A, if reported |
| | SINR #1 as in Table 6.3.1.1.2-6A, if reported |
| | Differential SINR #2 as in Table 6.3.1.1.2-6A, if reported |
| | Differential SINR #3 as in Table 6.3.1.1.2-6A, if reported |
| | Differential SINR #4 as in Table 6.3.1.1.2-6A, if reported |
| | CapabilityIndex #1 as in Table 6.3.1.1.2-6, if reported |
| | CapabilityIndex #2 as in Table 6.3.1.1.2-6, if reported |
| | CapabilityIndex #3 as in Table 6.3.1.1.2-6, if reported |
| | CapabilityIndex #4 as in Table 6.3.1.1.2-6, if reported |

A mapping order of CSI report #n in UCI shown in Table 36 and Table 38 corresponds to the order of CSI report #1, CSI report #2, . . . , and CSI report #n, and priority for determining the order of CSI reports may be determined by referring to Clause 5.2.5 in TS 38.214.

The disclosure provides a CSI-RS reception method of a UE and a method of reporting measured CSI, the method being applied when a base station is to operate multiple beams with the reduced amount of CSI-RSs for beam operation. Specifically, if a beam set to be used by the base station to transmit a UE-dedicated PDSCH is Set A and a beam set for beam measurement and reporting used by the UE to select an optimal beam is Set B, the UE selects an optimal beam in the following conventional method.
Method 1: Set B is the same as Set A. The beams of Set B are mapped to different SSBs or CSI-RSs. The UE may measure all the SSBs or CSI-RSs mapped to the beams of Set B and report the index and L1-RSRP of an SSB or CSI-RS having the greatest L1-RSRP. The base station may select a beam in Set A through the report from the UE and use the selected beam as a PDSCH transmission beam.
Method 2: Set B is different from Set A or is a subset of Set A. Set B may be divided into Set B1 and Set B2, the beams of Set B1 may be configured by beams having a wide beam width, and Set B2 may be a subset of Set A and may be configured by beams having a smaller beam width compared to Set B1. The UE may measure all the SSBs or CSI-RSs mapped to the beams of Set B1 and report the index and L1-RSRP of an SSB or CSI-RS having the greatest L1-RSRP. The base station may select a beam in Set B1 through the report from the UE and configure (or set) a beam in Set B2 by using the selected beam. The UE may measure all the CSI-RSs mapped to the beams of Set B2 and report the index and L1-RSRP of a CSI-RS having the greatest L1-RSRP. The base station may select a beam in Set A through the report from the UE and use the selected beam as a PDSCH transmission beam.

Both the conventional methods 1 and 2 need at least an optimal beam in Set B to select a beam in Set A. Therefore, in order to select the optimal beam within Set B, numerous beam sweeping operations is required, which increases the overhead of DL-RSs and the latency of beam operation.

The base station or the UE may utilize a high-performance beam estimation algorithm to select or predict the optimal beam within Set A, which is not included in Set B, based on recent measurement data of Set B. This high-performance beam estimation algorithm may be implemented using various beam estimation algorithms including an artificial intelligence (AI)-based channel estimation algorithm, and may provide the following benefits.
Benefit 1: Since it is unnecessary to include, in Set B, the optimal beam in Set A, the overhead of SSBs or CSI-RSs for measuring the beams in Set B may be reduced. For example, in order to use a transmission beam having a narrower beamwidth (and higher beam gain) than a beam mapped to an SSB, a transmission beam having a narrower beamwidth may be mapped to a CSI-RS. However, the mapping requires CSI-RSs to be configured for each UE. Therefore, if there are many beams in Set B, when a large number of UEs are supported, the amount of CSI-RS overhead may significantly increase.
Benefit 2: Since the base station may receive a report of a beam estimated by the UE or estimate a beam not measured and reported within Set B, the base station may predict future beams within Set A, thereby reducing the latency of beam operation and maintaining continuous beam reception quality. For instance, at the time point at which a beam change is needed, latency caused by beam sweeping and CSI-report may prevent the UE from receiving the optimal beam in time, or the L1-RSRP may become aged, resulting in failure to receive the optimal beam. In a case of predicting a future beam, the base station may predict an optimal beam before the time point at which a beam change is required, and indicate the beam change to the UE with the reduced latency.
Benefit 3: The UE may reduce the number of SSBs or CSI-RSs for measuring beams, thereby saving power consumption for CSI measurement. For example, in a case where the number of CSI-RSs actually operated by the base station is larger than the number of beams in Set B, even if the UE does not measure all the CSI-RSs operated by the base station and measure and report only the beams in Set B, the base station may achieve beam operation having beam estimation performance similar to that of when all the CSI-RSs are measured and reported.

As described above, the base station or the UE may utilize a high-performance beam estimation algorithm to select or predict the optimal beam within Set A, which is not included in Set B, based on recent measurement data of Set B.

Although, in the disclosure, for explanation, the number of beams in Set B is assumed to be M, and the beamwidth used for the CSI-RS is assumed to be narrower than that used for the SSB, the scope of the disclosure is not limited to these ranges.

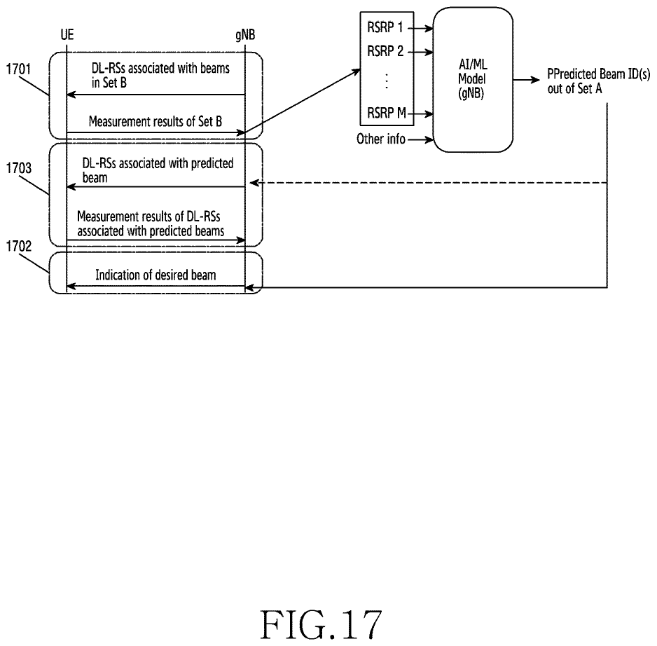

FIG. 17 illustrates an example of beam measurement and reporting for beam estimation according to an embodiment of the disclosure. Referring to FIG. 17, the UE assumes that “Set A” number of CSI-RSs to which a total of “Set A” number of transmission beams are mapped have been configured. According to an embodiment of FIG. 17, the UE may receive DL RSs related to M beams in Set B, and report CSI, based on a result of measuring L (≤M) beams thereamong (operation 1701).

The base station may provide an indication related to beam operation through the CSI of the L beams reported from the UE (operation 1702). This indication process may include a process of transmitting, by the base station, information indicating a desired beam to the UE. In addition, the base station may indicate CSI measurement and reporting of beams to be selectively operated (operation 1703). The process of indicating beams to be selectively operated may include a process of transmitting, by the base station, a DL-RS related to a prediction beam predicted based on the CSI report from the UE.

The greater the value of L, which is the number of beams reported by the UE, the more precisely the base station may predict an optimal beam (or prediction beam). The greater the number of beams to be reported, the higher the probability that the value of a differential RSRP that is a difference from the maximum RSRP is smaller than-30 dB. The greater the number of beams to be reported by the UE, the greater the overhead of UCI. Therefore, when there are a large number of beams having a value of the differential RSRP smaller than-30 dB, reporting the RSRPs of the beams may be inefficient. In addition, when CSI of beams having a value of the differential RSRP smaller than-30 is reported according to the implementation of the beam estimation algorithm of the base station, beam estimation accuracy may be better. Therefore, by extending the range of the differential RSRP values of corresponding beams to enable the UE to report values smaller than-30 dB supported in the current specification, the beam estimation accuracy of the base station may be enhanced. In a case where the number of beams in Set B to be measured and reported by the UE is greater than 4, a method of reporting L CSIs is as follows.
Method 1: According to the conventional scheme, when groupBasedBeamReporting-r17 is not configured, a single CSI-SSB-ResourceSet or NZP-CSI-RS-ResourceSet is configured for channel measurement for each CSI-ReportConfig, and reporting CSI of up to 4 beams is possible for each ResourceSet (CSI-SSB-ResourceSet or NZP-CSI-RS-ResourceSet). Therefore, for example, when nrofReportedRS is configured to be 4, if N ResourceSets in (N=M/nrofReportedRS) number of CSI-ReportConfigs are configured and four nzp-CSI-RS-Resources or four SSBs are configured in each ResourceSet, the UE may measure all the beams in Set B and report a total of (L=M=4N) number of CSIs. This method is advantageous in that there is no need to change the existing specification. However, the base station is unable to know sets among N sets to which L beams having the largest RSRP value among M beams belong until CSI is reported from the UE. Therefore, when L is smaller than M, it is not possible to report the L beams having the largest RSRP value.
Method 2: If a single ResourceSet is configured for channel measurement in a single CSI-ReportConfig, and M CSI-RS resources or M SSBs are configured to report L beams, the UE may measure beams in Set B and report a total of L CSIs. Unlike Method 1, the UE may report L beams having the largest RSRP value among M beams. In the conventional method, it is possible to report a maximum of L=4 beams, and thus a specification change is required when L is greater than 4 (L>4).

In both Method 1 and Method 2 described above, when L is greater than 4 (L>4), the overhead of UCI for CSI reporting increases in proportional to L, compared to that of the conventional case of L being equal to 4 (L=4). For example, in a case where L is equal to M which is equal to 16 (L=M=16) and the number of beams in Set A is 4, when CSI of beams in Set B is reported in a system using the beam estimation algorithm of the base station, the number of CSI bits is 108. On the contrary, when beams in Set A are measured and reported in a system in which the base station does not use the beam estimation algorithm, the number of CSI bits is 43. Therefore, the UCI overhead the UE needs to report becomes equal to or greater than double. In the above description, for explanation, L1-RSRP measurement and reporting has been described as an example, but this does not limit the scope of the disclosure. In the following embodiments, a method of measuring and reporting CSI while reducing UCI overhead in Method 1 and Method 2 is disclosed.

### First Embodiment: a Method of Measuring and Reporting CSI for Beam Operation when Multiple CSI-SSB-ResourceSets or NZP-CSI-RS-ResourceSets are Configured

The first embodiment of the disclosure describes a method of measuring and reporting CSI for beam operation when multiple CSI-SSB-ResourceSets or NZP-CSI-RS-ResourceSets are configured. Through the CSI measurement and reporting method according to an embodiment of the disclosure, the amount of CSI reporting for M=L may be reduced, and it is possible to perform beam operation having performance comparable to the system in which the amount of CSI reporting is not reduced.

For example, when one reference CRI or reference SSBRI serving as a criterion of differential RSRP or differential SINR is shared between N ResourceSets, it is sufficient to report only the differential RSRP or differential SINR with respect to a ResourceSet having no reference CRI or reference SSBRI, and thus the amount of CSI reporting may be reduced. In addition, since the number of beams to be reported is equal to the number of beams configured for CSI measurement and reporting, if a CRI or SSBRI corresponding to a differential RSRP or differential SINR to be reported by the UE is promised in advance, the base station may identify CSI of which beam the reported differential RSRP or differential SINR corresponds to, even when the CRI or SSBRI is not reported by the UE.

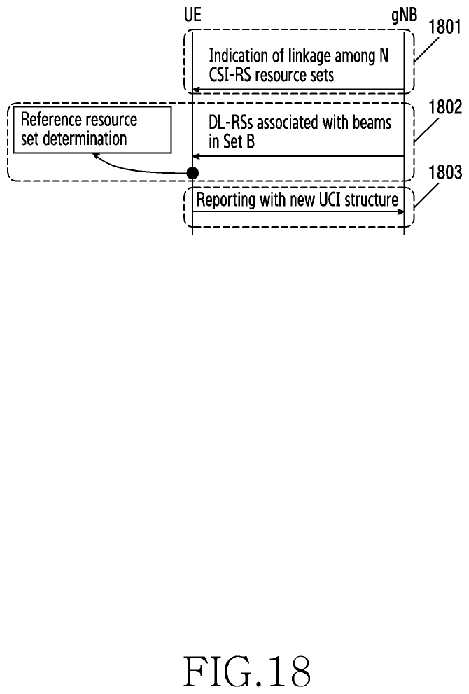

FIG. 18 illustrates an example of a method of performing CSI measurement and reporting for beam operation when multiple CSI-SSB-ResourceSets or NZP-CSI-RS-ResourceSets are configured, according to an embodiment of the disclosure. Referring to FIG. 18, a UE receives information indicating linkage between N ResourceSets from a base station (operation 1801). The UE may receive and measure DL-RSs related to beams in Set B to determine a reference ResourceSet including a reference CRI or reference SSBRI among the linked N ResourceSets (operation 1802). The UE may report CSI of the beams in a new UCI structure according to Method 2 or Method 3 of the first embodiments described below, based on the reference ResourceSet (operation 1803). A detailed method therefor is described below.
Method 1: The linkage between the N ResourceSets may be configured for the UE.
Method 1-1: The linkage may be explicitly configured for the UE through higher layer configuration. In an embodiment, N SI-SSB-ResourceSetIDs or N NZP-CSI-RS-ResourceSetIDs may be configured in assoicatedCSI-ResourceSets-r19.
Method 1-2: The linkage may be implicitly configured for the UE through higher layer configuration. In an embodiment, if the number of beams to be reported, which is configured in nrofReportedRS, is equal to the number of nzp-CSI-RS-Resources configured in each corresponding NZP-CSI-RS-ResourceSet or the number of SSBs configured in a CSI-SSB-ResourceSet, and N CSI-ReportConfigs connected to N ResourceSets are triggered (or configured) to be concurrently reported through the same PUSCH or PUCCH, the UE may assume (or determine) that the N ResourceSets are linked.
Method 2: If the UE is aware that the N ResourceSets are linked through Method 1, the UE may determine a reference ResourceSet among the measured ResourceSets. The UE may report CSI in a new UCI structure, based on the determined reference ResourceSet. A detailed method therefor is described below.
Method 2-1: The UE may determine, as a reference ResourceSet, a ResourceSet configured in a CSI-ReportConfig having the smallest CSI-ReportConfigId value among the linked N ResourceSets. In an embodiment, if the number of beams configured in nrofReportedRS is referred to as K, a CSI report triggered by a CSI-ReportConfig corresponding to the reference ResourceSet may include CRI or SSBRI #1, CRI or SSBRI #2, . . . , CRI or SSBRI #K, RSRP #1, Differential RSRP #2, . . . , and Differential RSRP #K. A CSI report triggered by a CSI-ReportConfig not corresponding to the reference ResourceSet may include CRI or SSBRI #1, CRI or SSBRI #2, . . . , CRI or SSBRI #K, Differential RSRP #1, Differential RSRP #2, . . . , Differential RSRP #K, and a 1-bit sign (+or −) of the differential RSRP of a beam having the largest RSRP among K beams. If the sign of the differential RSRP of a beam having the largest RSRP is different from the sign of the differential RSRP of a beam to be reported, the UE may report the beam by assuming that the differential RSRP of the beam to be reported is 0.
Method 2-2: The UE may determine, as a reference ResourceSet, a ResourceSet having the smallest (or weakest) CSI-SSB-ResourceSetID or NZP-CSI-RS-ResourceSetID value among the linked N ResourceSets. In an embodiment, if the number of beams configured in nrofReportedRS is referred to as K, a CSI report triggered by a CSI-ReportConfig corresponding to the reference ResourceSet may include CRI or SSBRI #1, CRI or SSBRI #2, . . . , CRI or SSBRI #K, RSRP #1, Differential RSRP #2, . . . , and Differential RSRP #K. A CSI report triggered by a CSI-ReportConfig not corresponding to the reference ResourceSet may include CRI or SSBRI #1, CRI or SSBRI #2, . . . , CRI or SSBRI #K, Differential RSRP #1, Differential RSRP #2, . . . , Differential RSRP #K, and a 1-bit sign (+or −) of the differential RSRP of a beam having the largest RSRP among K beams. If the sign of the differential RSRP of a beam having the largest RSRP is different from the sign of the differential RSRP of a beam to be reported, the UE may report the beam by assuming that the differential RSRP of the beam to be reported is 0.
Method 2-3: The UE may determine, as a reference ResourceSet, a ResourceSet including a beam having the highest (or strongest) RSRP among the linked N ResourceSets. In an embodiment, if the number of beams configured in nrofReportedRS is referred to as K, a first CSI report among CSI reports triggered by N CSI-ReportConfigs may report CSI of the reference ResourceSet, and may include CRI or SSBRI #1, CRI or SSBRI #2, . . . , CRI or SSBRI #K, RSRP #1, Differential RSRP #2, . . . , Differential RSRP #K, and the [log 2 N]-bit ID of the reference ResourceSet. A second and subsequent CSI reports among the CSI reports triggered by the N CSI-ReportConfigs may report CSI of the remaining ResourceSets rather than the reference ResourceSet, and may include CRI or SSBRI #1, CRI or SSBRI #2, . . . , CRI or SSBRI #K, Differential RSRP #1, Differential RSRP #2, . . . , and Differential RSRP #K.
Method 2-4: The UE may determine, as a reference ResourceSet, a ResourceSet including a beam having an RSRP corresponding to a middle value among the linked N ResourceSets. For example, the UE may determine, as a reference ResourceSet, a ResourceSet including a beam having the [M/2] th strongest RSRP, but the disclosure is not limited to this example. In an embodiment, if the number of beams configured in nrofReportedRS is referred to as K, a first CSI report among CSI reports triggered by N CSI-ReportConfigs may report CSI of the reference ResourceSet, and may include CRI or SSBRI #1, CRI or SSBRI #2, . . . , CRI or SSBRI #K, RSRP #1, Differential RSRP #2, . . . , Differential RSRP #K, and the [log 2 N]-bit ID of the reference ResourceSet. A second and subsequent CSI reports among the CSI reports triggered by the N CSI-ReportConfigs may report CSI of the remaining ResourceSets rather than the reference ResourceSet, and may include CRI or SSBRI #1, CRI or SSBRI #2, . . . , CRI or SSBRI #K, Differential RSRP #1, Differential RSRP #2, . . . , Differential RSRP #K, and a 1-bit sign (+or −) of the differential RSRP of a beam having the largest RSRP among K beams. If the sign of the differential RSRP of a beam having the largest RSRP is different from the sign of the differential RSRP of a beam to be reported, the UE may report the beam by assuming that the differential RSRP of the beam to be reported is 0.
Method 2-5: The UE may not determine a reference ResourceSet among the linked N ResourceSets. According to Method 2-5, the UE may report only RSRP values as CSI without reference CRI reporting. The UE may expect that “RSRP” or “RSRP-CapabilityIndex” is configured therefor as reportQuantity, or if N ResourceSets being linked is configured for the UE, even when information configuring, as reportQuantity, “cri-RSRP,” “ssb-Index-RSRP,” “cri-RSRP-CapabilityIndex,” or “ssb-Index-RSRP-CapabilityIndex” is received, the UE may omit CRI or SSBRI reporting. In an embodiment, if the number of beams configured in nrofReportedRS is referred to as K, each of the CSI reports triggered by the N CSI-ReportConfigs may include RSRP #1, RSRP #2, . . . , and RSRP #K. The UE may assume that RSRP #k is an RSRP measured on CRI #(k−1) or SSBRI #(k−1) configured in a ResourceSet.

In Method 2-1 to Method 2-5 described above, RSRP reporting has been assumed for explanation, but the methods are also applicable to SINR reporting in the same manner. Method 2-1 and Method 2-2 described above are advantageous in that the conventional priority determination method is used to determine the priorities of N CSI reports configured in N CSI-ReportConfigs. Method 2-3 described above are advantageous in that the priorities of N CSI reports configured in N CSI-ReportConfigs are newly determined and thus the smallest UCI overhead is provided among Method 2-1 to Method 2-5 described above. Method 2-4 described above are advantageous in that the priorities of N CSI reports configured in N CSI-ReportConfigs are newly determined and thus the most correct reportable differential RSRP values are provided among Method 2-1 to Method 2-4 described above. Method 2-5 described above are advantageous in that the most correct reportable RSRP values are provided among Method 2-1 to Method 2-5 described above.
Method 3: If the UE is aware that the N ResourceSets are linked through Method 1, the UE may omit, from the CSI reports of Method 2-1 and Method 2-2 described above, reporting CRI or SSBRI #k (in a case of a reference Resource Set, k=2, . . . , and K, and in a case of sets other than the reference Resource Set, k=1, . . . , and K) except for CRI or SSBRI #1 for reporting a reference CRI or SSBRI in the reference ResourceSet, and may report CSI in a new UCI structure. Specifically, the UE may expect that “cri1-RSRP,” “cri1-RSRP-CapabilityIndex,” “ssb-Index1-RSRP,” or “ssb-Index1-RSRP-CapabilityIndex” is configured therefor as reportQuantity, or if N ResourceSets being linked is configured for the UE, even when information configuring, as reportQuantity, “cri-RSRP,” “ssb-Index-RSRP,” “cri-RSRP-CapabilityIndex,” or “ssb-Index-RSRP-CapabilityIndex” is received, the UE may omit reporting CRI or SSBRI #k (in a case of a reference Resource Set, k=2, . . . , and K, and in a case of sets other than the reference Resource Set, k=1, . . . , and K) except for CRI or SSBRI #1. In order to report CSI of beams in the reference ResourceSet, the UE may assume that Differential RSRP #k corresponds to the (k−1)th beam configured in the ResourceSet, except for the beam corresponding to CRI or SSBRI #1. In order to report CSI of beams in a ResourceSet rather than the reference ResourceSet, the UE may assume that Differential RSRP #k is a differential RSRP measured on CRI #(k-1) or SSBRI #(k-1) configured in the ResourceSet.

In Method 3 described above, RSRP reporting has been assumed for explanation, but the method is also applicable to SINR reporting in the same manner. When Method 3 described above is applied to Method 2-1 to Method 2-4, the UE does not report a part of CRIs or SSBRIs and thus UCI overhead may be reduced significantly.

### Second Embodiment: a Method of Measuring and Reporting CSI for Beam Operation when a Single CSI-SSB-ResourceSet or NZP-CSI-RS-ResourceSet is Configured

A second embodiment of the disclosure describes a method of measuring and reporting CSI for beam operation when a single CSI-SSB-ResourceSet or NZP-CSI-RS-ResourceSet is configured. Through the CSI measurement and reporting method according to an embodiment of the disclosure, the UE may report only some L beams without reporting all of M beams, thereby reducing the amount of CSI reporting and obtaining beam operation performance comparable to the system in which the amount of CSI reporting is not reduced. For example, the UE may receive information configuring or indicating L from the base station and transmit a report for L beams as single part CSI, or the UE may determine L and transmit a report for L beams as two part CSI having a variable payload size of UCI.

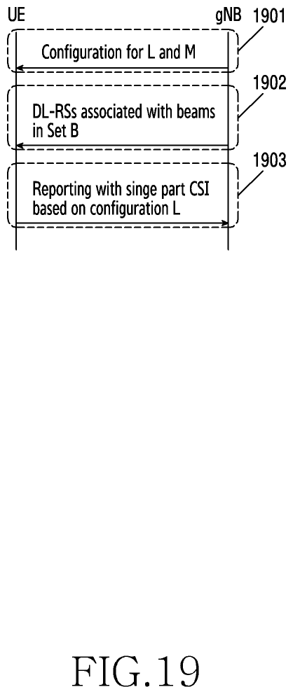

FIG. 19 illustrates an example of a method of measuring CSI for beam operation and reporting the measured CSI as single part CSI when a single CSI-SSB-ResourceSet or NZP-CSI-RS-ResourceSet is configured, according to an embodiment of the disclosure. Referring to FIG. 19, a UE receives, from a base station, information for configuring L, which is the number of beams to be reported, and information for configuring M, which is the number of all the beams in Set B (operation 1901). The UE may receive DL-RSs related to M beams in Set B, measure the DL-RSs, and determine L beams to be reported (operation 1902). The UE may report CSI for the measured L beams as single part CSI (operation 1903). A detailed method therefor is described below.
Method 1: The UE may report differential RSRP by extending the range thereof.
Method 1-1: The UE may determine the bitwidth of differential RSRP according to the configured L value. For example, when L is from 1 to 4, the bitwidth may be determined as 4, which is the same size as the conventional configuration. When L is from 5 to 8, the bitwidth may be determined as 5, and the range may be [0, −2, . . . , −64] dB. When L is 9 or greater, the bitwidth may be determined as 6, and the range may be expected to be [0, −2, . . . , −94] dB. The aforementioned L values and range values are merely examples, and the content of the disclosure is not limited to such values.
Method 1-2: The UE may determine the step size of differential RSRP according to the configured L value. For example, when L is from 1 to 4, the step size may be determined as 2 dB, which is the same size as the conventional configuration. When L is from 5 to 8, the step size may be determined as 4 dB, and the range may be [0, −2, . . . , −60] dB. When L is 9 or greater, the step size may be determined as 6 dB, and the range may be expected to be [0, −2, . . . , −90] dB. The bitwidth of differential RSRP is the same with respect to all values of L. The aforementioned L values, step sizes, and range values are merely examples, and the content of the disclosure is not limited to such values.
Method 1-3: The UE may report two or more reference CRIs or SSBRIs. The number of reference CRIs or SSBRIs may be configured by a higher layer or determined by L. For example, if CRI or SSBRI #1 reported by the UE indicates the m-th reference CRI or SSBRI reported together by the UE, the differential RSRPs of CRI or SSBRI #(1+1) and subsequent CRIs or SSBRIs may be calculated based on the RSRP value of the m-th reference CRI or SSBRI.

Method 1-1 described above is advantageous in that the overhead of UCI may be increased by L, but accurate RSRP is reportable. Method 1-2 described above is advantageous in that the overhead of UCI is not increased by L unlike Method 1-1. Method 1-3 described above is advantageous in that, when additional reference CRIs or SSBRIs are reported, accurate RSRP is reportable.
Method 2: When the configured L and M are the same, the UE may not report all CRIs or SSBRIs or some CRIs or SSBRIs. As in the first embodiment described above, even when the UE does not report some CRIs or SSBRIs, if CRIs or SSBRIs corresponding to CSI of RSRPs to be reported are defined in advance, the UE may omit at least some CRIs or SSBRIs when reporting CSI.
Method 2-1: In a case where L and M are the same, the UE may expect that “cri1-RSRP,” “cri1-RSRP-CapabilityIndex,” “ssb-Index1-RSRP,” or “ssb-Index1-RSRP-CapabilityIndex” is configured therefor as reportQuantity, or even if information configuring, as reportQuantity, “cri-RSRP,” “ssb-Index-RSRP,” “cri-RSRP-CapabilityIndex,” or “ssb-Index-RSRP-CapabilityIndex” is received, the UE may omit reporting CRI or SSBRI #k except for CRI or SSBRI #1. In order to report CSI of beams, the UE may assume that Differential RSRP #k corresponds to the (k−1)th beam configured in a ResourceSet, except for the beam corresponding to CRI or SSBRI #1.
Method 2-2: The UE may expect not to report differential RSRPs and report L RSRPs. In a case where L and M are the same, the UE may expect that “RSRP” or “RSRP-CapabilityIndex” is configured therefor as reportQuantity, or even if information configuring, as reportQuantity, “cri-RSRP,” “ssb-Index-RSRP,” “cri-RSRP-CapabilityIndex,” or “ssb-Index-RSRP-CapabilityIndex” is received, the UE may omit reporting CRI or SSBRI #k. In order to report CSI of beams, the UE may assume that RSRP #k is an RSRP measured on CRI #(k−1) or SSBRI #(k−1) configured in a ResourceSet.
Method 2-1 described above is advantageous in that UCI overhead may be significantly reduced. Method 2-2 described above is advantageous in that the accuracy of RSRP to be reported may be improved.
Method 3: The UE may report differential RSRP by reducing the range thereof. The UE may determine the bitwidth of differential RSRP according to the configured L value. For example, when L is from 1 to 4, the UE may determine the bitwidth as 4, which is the same size as the conventional configuration. When L is from 5 to 8, the bitwidth may be determined as 3, and the range may be [0, −2, . . . , −14] dB. When L is 9 or greater, the bitwidth may be determined as 2, and the range may be expected to be [0, −2, . . . , −8] dB. The aforementioned L values and range values are merely examples, and the content of the disclosure is not limited to such values.

Method 3 described above is advantageous in that the overhead of UCI may be reduced compared to the conventional overhead.
Method 4: Depending on the values of L and M, and the bitwidth Z of RSRP or differential RSRP, the UE may report CRIs or SSBRIs of (M-L) number of RSRPs that are not to be reported, and may not report CRIs or SSBRIs of (L−1) number of differential RSRPs to be reported. Z may be determined by L in Method 1 or Method 3 described above, or may be predetermined by a higher layer indication or configuration or to be a particular value. In addition, the UE may expect that “cri1-ucri-RSRP-r19,” “ssb-Index1-ussb-Index-RSRP-r19,” “cri1-ucri-RSRP-CapabilityIndex-r19,” or “ssb-Index1-ussb-Index-RSRP-CapabilityIndex-r19” are configured therefor as a new reportQuantity, or even if information configuring, as reportQuantity, “cri-RSRP,” “ssb-Index-RSRP,” “cri-RSRP-CapabilityIndex,” or “ssb-Index-RSRP-CapabilityIndex is received, the UE may expect the following detailed reporting method. When the UE reports a CRI or SSBRI #k except for CRI or SSBRI #1, the UE may report CRI or SSBRI values corresponding to the RSRPs of (M-L) number of beams not to be reported. In order to report CSI of beams, the UE may assume that reported Differential RSRP #k corresponds to the (k−1)th beam among (L−1) number of beams configured in a ResourceSet, except for the beam corresponding to CRI or SSBRI #1 and the beam corresponding to CRI or SSBRI #k. The M, L, and Z configuration methods of various cases are described below in detail.
Method 4-1: When M≥M′, L≥L′, and Z≥Z′, the UE may expect the reporting method of Method 4. In an embodiment, when M′=8, L′= [M/2]+1, and Z′=4, and M=8, L=6, and Z=4, the UE may expect the reporting method of Method 4. In an embodiment, when M′=8, L′= [M/2]+1, and Z′=4, and M=8, L=6, and Z=2, the UE does not expect Method 4. That is, the UE may expect reporting based on a different report quantity. The aforementioned given values are merely examples, and the content of the disclosure is not limited to such values.
Method 4-2: When M ≥ M′ and L≥L′, the UE may expect the reporting method of Method 4. In an embodiment, when M′=8 and L′= [M/2]+1, and M=8 and L=6, the UE may expect the reporting method of Method 4. In an embodiment, when M′=8 and L′= [M/2]+1, and M=8 and L=4, the UE does not expect Method 4. That is, the UE may expect reporting based on a different report quantity. The aforementioned given values are merely examples, and the content of the disclosure is not limited to such values.
Method 4-3: When M>L≥L′, the UE may expect the reporting method of Method 4. In an embodiment, when L′=5, and M=16 and L=6, the UE may expect the reporting method of Method 4. In an embodiment, when L′=5, and M =16 and L=4, the UE does not expect Method 4. That is, the UE may expect reporting based on a different report quantity. The aforementioned given values are merely examples, and the content of the disclosure is not limited to such values.
Method 4-1 described above is advantageous in that reporting with a report quantity providing the minimum number of UCI bits is possible by combining all M, L, and Z values. For example, the method requiring the smallest number of UCI bits among the method of reporting all L CRIs or SSBRIs and L RSRPs or Method 2-1 described above and Method 4-1 described above may vary according to M, L, and Z values. Method 4-2 described above is a method that is available when the Z value is fixed to 4, which is the conventional value, or is predetermined by Method 1 or Method 3 described above. Method 4-3 described above is advantageous in that a report quantity is simply determined.

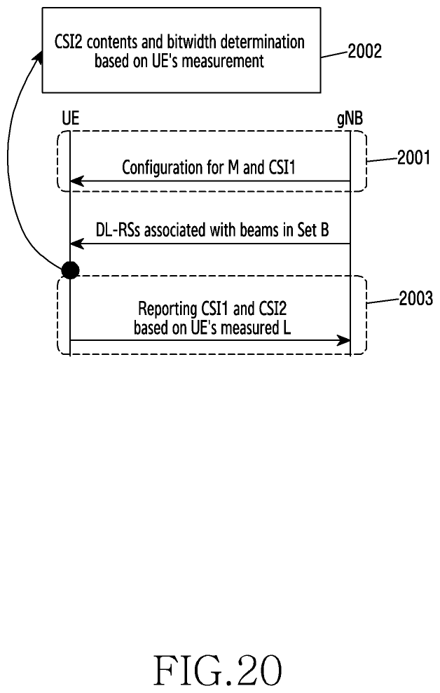

FIG. 20 illustrates an example of a method of measuring CSI for beam operation and reporting the measured CSI as two part CSI when a single CSI-SSB-ResourceSet or NZP-CSI-RS-ResourceSet is configured, according to an embodiment of the disclosure. Referring to FIG. 20, a UE receives, from a base station, configuration information on CSI part 1 (CSI1) to be reported and configuration information on M, which is the number of beams (operation 2001). The UE may receive DL-RSs related to M beams in Set B, measure the DL-RSs, and determine CSI to be reported in CSI part 2 (CSI2) to be reported and the bitwidth of CSI2, based on a result of the measurement (operation 2002). The UE may report CSI for the measured L beams as two part CSI (operation 2003). A detailed method therefor is described below.
Method 5: The UE may select CSI of some beams among the measured M beams and report the selected CSI as two part CSI. The size of CSI2 is determined based on CSI1, and the size of CSI1 may be determined by a higher layer configuration. The UE may also report only CSI1 among CSI1 and CSI2.
Method 5-1: The UE may report, in CSI2, CSI of (L-nrofReportedRS) beams only when a corresponding differential RSRP value is equal to or greater than or exceeds the minimum value of reportable differential RSRP values. In an embodiment, the UE may report, in CSI1, (nrofReportedRS) number of beams and a “CSI2 Indicator” for determining the size of CSI2. The value of the CSI2 Indicator may be determined by the following methods.
Method 5-1-1: The value may be defined as the value of (L-nrofReportedRS).
Method 5-1-2: The value may be defined as a bitmap of CRIs or SSBRIs except for CRI or SSBRI #1.
Method 5-1-3: The value may be defined as a bitmap of CRIs or SSBRIs except for CRI or SSBRI #1 to CRI or SSBRI #nrofReportedRS.
Method 5-1-4: The value may be defined as the value of (M-L).

In Method 5-1-2 and Method 5-1-3 described above, the CRIs or SSBRIs included in the bitmap of CRIs or SSBRIs may not be reported.
Method 5-2: The UE may report, in CSI2, the least significant bits (LSBs) of a differential RSRP when the corresponding differential RSRP value is equal to or smaller than or is smaller than-30 dB of a reportable differential RSRP value. In an embodiment, the UE may report, in CSI1, the most significant bits (MSBs) of the differential RSRP of each of (nrofReportedRS-1) number of beams and a “CSI2 Indicator” for determining the size of CSI2. The number of MSBs of a differential RSRP is 4 bits which is the same as the conventional configuration. The value of the CSI2 Indicator may be determined by the following methods.
Method 5-2-1: The value may be defined as the value of the number of beams to be reported in CSI2. The number of LSBs may be configured by a higher layer. If the number of LSBs is configured to be 0, the UE may expect that CSI2 is not reported.
Method 5-2-2: The value may be defined as the values including the value of the number of beams to be reported in CSI2 and the number of LSBs.
Method 5-2-3: The value may be defined as the value of the number of beams not to be reported in CSI2. The number of LSBs may be configured by a higher layer. If the number of LSBs is configured to be 0, the UE may expect that CSI2 is not reported.
Method 5-2-4: The value may be defined as the values including the value of the number of beams not to be reported in CSI2 and the number of LSBs.

In an embodiment, if the bit value of the differential RSRP of a beam reported by the UE in CSI1 is 1011 and the beam is a beam not indicated by the CSI2 indicator, the base station may, when CSI1 is reported, interpret the bit value 1011 as the existing differential RSRP value of −22 dB. If the bit value of the differential RSRP of a beam reported by the UE in CSI1 is 1011 and the beam is a beam indicated by the CSI2 indicator, the base station may, when only CSI1 is reported, interpret the bit value 1011 as −30 dB which is a minimum differential RSRP value. Subsequently, when the value of 11, which is the LSBs of the differential RSRP of the beam, is additionally reported in CSI2, the base station may combine the value of 11 with the value of 1011, which is the bit value of the MSBs reported in CSI1, to interpret the differential RSRP value of the beam as −118 dB that is the bit value of 101111. The bit values and numerical values of dB described above merely correspond to an embodiment, and the content proposed in the disclosure is not limited to those numerical values or values.
Method 5-3: The UE may report, in CSI2, a differential RSRP when the differential RSRP value is smaller than-30 dB of a reportable differential RSRP value. For explanation, the UE may assume X as the number of beams to be reported in CSI2 when a corresponding differential RSRP value is smaller than-30 dB of a reportable differential RSRP value. In an embodiment, the UE may report, in CSI1, a maximum of four beams and a “CSI2 Indicator” for determining the size of CSI2. The minimum number of beams to be reported in CSI2, “nrofReportedRS-r19,” may be configured in the UE. The value of the CSI2 Indicator may be determined by the following methods.
Method 5-3-1: The value may be defined as the value of X. The number of bits of the differential RSRP of each of X beams may be configured by a higher layer.
Method 5-3-2: The value may be defined as the values including the value of X and the value of the number of bits of the differential RSRP of each of the X beams.
Method 5-3-3: The value may be defined as a bitmap of CRIs or SSBRIs of beams to be reported in CSI2. In CSI2, reporting CRIs or SSBRIs may be omitted.
Method 5-3-4: The value may be defined as the value of X′ that is the number of beams not to be reported in CSI2. The number of bits of the differential RSRP of each of X beams may be configured by a higher layer.
Method 5-3-5: The value may be defined as the values including the value of X′ and the value of the number of bits of the differential RSRP of each of the X beams.
Method 5-1 described above is advantageous in that overhead may be significantly reduced. Method 5-2 and Method 5-3 described above is advantageous in that accurate RSRP is reportable, compared to Method 5-1. Method 5-3 described above is advantageous in that the size of CSI1 is very small.
Method 5-4: The UE may report, in CSI2, the least significant bits (LSBs) of a differential RSRP when the corresponding differential RSRP value is equal to or smaller than or is smaller than-Y dB of a reportable differential RSRP value. In an embodiment, the UE may report, in CSI1, the most significant bits (MSBs) of the differential RSRP of each of (nrofReportedRS-1) number of beams and a “CSI2 Indicator” for determining the size of CSI2. The number of MSBs of a differential RSRP is Z bits. The value of the CSI2 Indicator may be determined by the following methods.
Method 5-4-1: The value may be defined as the value of the number of beams to be reported in CSI2. The number of LSBs may be configured by a higher layer. If the number of LSBs is configured to be 0, the UE may expect that CSI2 is not reported.
Method 5-4-2: The value may be defined as the values including the value of the number of beams to be reported in CSI2 and the number of LSBs.
Method 5-4-3: The value may be defined as the value of the number of beams not to be reported in CSI2. The number of LSBs may be configured by a higher layer. If the number of LSBs is configured to be 0, the UE may expect that CSI2 is not reported.
Method 5-4-4: The value may be defined as the values including the value of the number of beams not to be reported in CSI2 and the number of LSBs.

In an embodiment, if Y=14 and Z=3, the bit value of the differential RSRP of a beam reported by the UE in CSI1 is 101, and the beam is a beam not indicated by the CSI2 indicator, the base station may, when CSI1 is reported, interpret the bit value 101 as −12 dB that is a differential RSRP value corresponding to the Z bits. If the bit value of the differential RSRP of a beam reported by the UE in CSI1 is 101 and the beam is a beam indicated by the CSI2 indicator, the base station may, when only CSI1 is reported, interpret the bit value 101 as −14 dB which is a minimum differential RSRP value. Subsequently, when the value of 1, which is the LSBs of the differential RSRP of the beam, is additionally reported in CSI2, the base station may combine the value of 1 with the value of 101, which is the bit value of the MSBs reported in CSI1, to interpret the differential RSRP value of the beam as −24 dB that is the bit value of 1011. The bit values and numerical values of dB described above merely correspond to an embodiment, and the content proposed in the disclosure is not limited to those numerical values or values.
Method 5-5: The UE may report, in CSI2, a differential RSRP when the differential RSRP value is smaller than-Y dB of a reportable differential RSRP value. For explanation, the UE may assume X as the number of beams to be reported in CSI2 when a corresponding differential RSRP value is smaller than-Y dB of a reportable differential RSRP value. In an embodiment, the UE may report, in CSI1, a maximum of four beams and a “CSI2 Indicator” for determining the size of CSI2. The minimum number of beams to be reported in CSI2, “nrofReportedRS-r19,” may be configured in the UE. The value of the CSI2 Indicator may be determined by the following methods.
Method 5-5-1: The value may be defined as the value of X. The number of bits of the differential RSRP of each of X beams may be configured by a higher layer.
Method 5-5-2: The value may be defined as the values including the value of X and the value of the number of bits of the differential RSRP of each of the X beams.
Method 5-5-3: The value may be defined as a bitmap of CRIs or SSBRIs of beams to be reported in CSI2. In CSI2, reporting CRIs or SSBRIs may be omitted.
Method 5-5-4: The value may be defined as the value of X′ that is the number of beams not to be reported in CSI2. The number of bits of the differential RSRP of each of X beams may be configured by a higher layer.
Method 5-5-5: The value may be defined as the values including the value of X′ and the value of the number of bits of the differential RSRP of each of the X beams.
Method 5-4 and Method 5-5 described above is advantageous in that overhead may be significantly reduced. Method 5-5 described above is advantageous in that the size of CSI1 is very small.

For detailed explanation, in an embodiment, if M=16 and Y=14, the number of beams to be reported in CSI1 is configured to be 4, and the minimum number of beams to be reported in CSI2 is configured to be 0, when the number X of beams to be reported by the UE in CSI2 is 4, the UE may report X=4 according to Method 5-5-1 and report X′=8 according to Method 5-5-4 in CSI1 as a CSI2 Indicator. In Method 5-5-1 and Method 5-5-4, the number of bits of the CSI2 Indicator may be determined to be log 2=4. If the maximum number of bits of the differential RSRP of each of the X beams to be reported by the UE in CSI2 is 5, the number of bits to be reported is 4, and the number of bits of the differential RSRP of each of the beams to be reported in CSI1 is 3, the UE may report X=4 and 1, which is the number of bits differential RSRP, according to Method 5-5-2 and report X′=8 and 1, which is the number of bits differential RSRP, according to Method 5-5-5 in CSI1 as the CSI2 Indicator. In Method 5-5-1 and Method 5-5-4, the number of bits of the CSI2 Indicator may be determined to be log ₂+1=5. The aforementioned given values are merely examples, and the content of the disclosure is not limited to such values.

The above-described first and second embodiments of the disclosure have been described assuming beam operation for illustrative purposes. However, all embodiments and detailed methods of the disclosure are not limited to beam operation alone. For example, the described embodiments and relevant detailed methods may also be used when the UE reports predicted PMI, i1, or CQI.

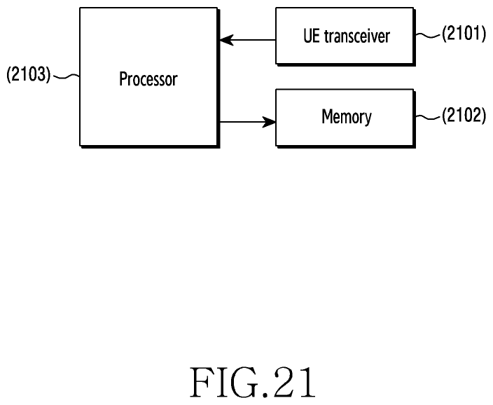

FIG. 21 illustrates a structure of a UE in a wireless communication system according to an embodiment of the disclosure. Referring to FIG. 21, the UE may include a transceiver, which refers to a UE receiver A00 and a UE transmitter A10 as a whole, a memory (not illustrated), and a UE processor A05 (or UE controller or processor). The UE transceiver A00 and A10, the memory, and the UE processor A05 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

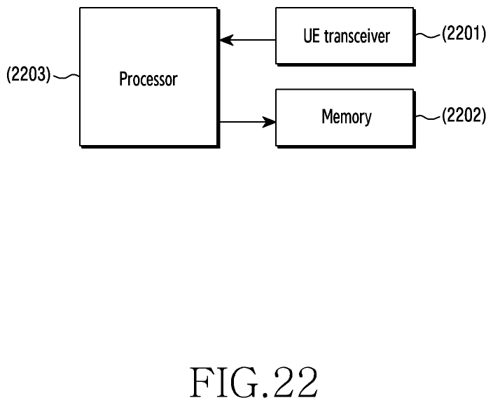

FIG. 22 illustrates a structure of a base station in a wireless communication system according to an embodiment of the disclosure.

Referring to FIG. 22, the base station may include a transceiver, which refers to a base station receiver B00 and a base station transmitter B10 as a whole, a memory (not illustrated), and a base station processor B05 (or base station controller or processor). The base station transceiver B00 and B10, the memory, and the base station processor B05 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a user equipment (UE) in a wireless communication system, the method comprising:
receiving, from a base station, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources;
receiving, from the base station, a downlink reference signal on the one or more downlink reference signal resources, based on the information on the one or more downlink reference signal resources;
obtaining the first measurement results, based on the received downlink reference signal; and
transmitting, to the base station, the measurement result report that is based on the configured number of the second measurement results including a reference measurement result based on the first measurement results,
wherein the measurement result report comprises information on the reference measurement result and information on a differential of, from the reference measurement result, each of one or more measurement results other than the reference measurement result, and
wherein a range of a value indicated by the information on the differential is determined based on a value indicated by the information for configuring the number.

2. The method of claim 1, wherein the value indicated by the information for configuring the number belongs to one of one or more ranges not overlapping with each other, and
wherein the range of the value indicated by the information on the differential is extended based on an identical upper limit value, based on an increase of a lower limit value of the range to which the value indicated by the information for configuring the number belongs.

3. The method of claim 2, wherein a bitwidth of the information on the differential is configured to be identical,
wherein a difference value between values indicated by two consecutive bit values of the information on the differential increases, based on an increase of a lower limit value of the range to which the value indicated by the information for configuring the number belongs, and
wherein a bitwidth of the information on the differential is configured to be identical.

4. The method of claim 2, wherein a bitwidth of the information on the differential increases, based on an increase of a lower limit value of the range to which the value indicated by the information for configuring the number belongs, and
wherein a difference value between values indicated by two consecutive bit values of the information on the differential is configured to be identical.

5. A method performed by a base station in a wireless communication system, the method comprising:
transmitting, to a UE, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources;
transmitting, to the UE, a downlink reference signal on the one or more downlink reference signal resources, based on the information on the one or more downlink reference signal resources; and
receiving, from the UE, the measurement result report that is based on the configured number of the second measurement results including a reference measurement result based on the first measurement results based on the transmitted downlink reference signal,
wherein the measurement result report comprises information on the reference measurement result and information on a differential of, from the reference measurement result, each of one or more measurement results other than the reference measurement result, and
wherein a range of a value indicated by the information on the differential is determined based on a value indicated by the information for configuring the number.

6. The method of claim 5, wherein the value indicated by the information for configuring the number belongs to one of one or more ranges not overlapping with each other, and
wherein the range of the value indicated by the information on the differential is extended based on an identical upper limit value, based on an increase of a lower limit value of the range to which the value indicated by the information for configuring the number belongs.

7. The method of claim 6, wherein a bitwidth of the information on the differential is configured to be identical,
wherein a difference value between values indicated by two consecutive bit values of the information on the differential increases, based on an increase of a lower limit value of the range to which the value indicated by the information for configuring the number belongs, and
wherein a bitwidth of the information on the differential is configured to be identical.

8. The method of claim 6, wherein a bitwidth of the information on the differential increases, based on an increase of a lower limit value of the range to which the value indicated by the information for configuring the number belongs, and
wherein a difference value between values indicated by two consecutive bit values of the information on the differential is configured to be identical.

9. A user equipment (UE) in a wireless communication system, the UE comprising:
a transceiver; and
a controller connected to the transceiver,
wherein the controller is configured to:
receive, from a base station, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources;
receive, from the base station, a downlink reference signal on the one or more downlink reference signal resources, based on the information on the one or more downlink reference signal resources;
obtain the first measurement results, based on the received downlink reference signal; and
transmit, to the base station, the measurement result report that is based on the configured number of the second measurement results including a reference measurement result based on the first measurement results,
wherein the measurement result report comprises information on the reference measurement result and information on a differential of, from the reference measurement result, each of one or more measurement results other than the reference measurement result, and
wherein a range of a value indicated by the information on the differential is determined based on a value indicated by the information for configuring the number.

10. The UE of claim 9, wherein the value indicated by the information for configuring the number belongs to one of one or more ranges not overlapping with each other, and
wherein the range of the value indicated by the information on the differential is extended based on an identical upper limit value, based on an increase of a lower limit value of the range to which the value indicated by the information for configuring the number belongs.

11. The UE of claim 10, wherein a bitwidth of the information on the differential is configured to be identical,
wherein a difference value between values indicated by two consecutive bit values of the information on the differential increases, based on an increase of a lower limit value of the range to which the value indicated by the information for configuring the number belongs, and
wherein a bitwidth of the information on the differential is configured to be identical.

12. The UE of claim 10, wherein a bitwidth of the information on the differential increases, based on an increase of a lower limit value of the range to which the value indicated by the information for configuring the number belongs, and
wherein a difference value between values indicated by two consecutive bit values of the information on the differential is configured to be identical.

13. A base station in a wireless communication system, the base station being configured to:
transmit, to a UE, first configuration information related to measurement for beam management and second configuration information associated with the first configuration information and including information on one or more downlink reference signal resources which are respectively related to different beams to be subject to the measurement, the first configuration information including information for configuring the number of second measurement results used for a measurement result report among first measurement results for the one or more downlink reference signal resources;
transmit, to the UE, a downlink reference signal on the one or more downlink reference signal resources, based on the information on the one or more downlink reference signal resources; and
receive, from the UE, the measurement result report that is based on the configured number of the second measurement results including a reference measurement result based on the first measurement results based on the transmitted downlink reference signal,
wherein the measurement result report comprises information on the reference measurement result and information on a differential of, from the reference measurement result, each of one or more measurement results other than the reference measurement result, and
wherein a range of a value indicated by the information on the differential is determined based on a value indicated by the information for configuring the number.

14. The base station of claim 13, wherein the value indicated by the information for configuring the number belongs to one of one or more ranges not overlapping with each other, and
wherein the range of the value indicated by the information on the differential is extended based on an identical upper limit value, based on an increase of a lower limit value of the range to which the value indicated by the information for configuring the number belongs.

15. The base station of claim 14, wherein a bitwidth of the information on the differential is configured to be identical,
wherein a difference value between values indicated by two consecutive bit values of the information on the differential increases, based on an increase of a lower limit value of the range to which the value indicated by the information for configuring the number belongs, and
wherein a bitwidth of the information on the differential is configured to be identical.
